(19) United States
(12) Patent Application Publication
(10) Pub. No.: US 2026/0116367 A1
(43) Pub. Date: Apr. 30, 2026

(54) ELECTRIC BRAKE SYSTEM AND METHOD OF CONTROLLING THE SAME

(71) Applicant: HL MANDO CORPORATION, Pyeongtaek (KR)

(72) Inventors: Yeonseong KIM, Pyeongtaek (KR); Kiwon KANG, Pyeongtaek (KR); Inwook JEON, Pyeongtaek (KR)

(21) Appl. No.: 19/019,989

(22) Filed: Jan. 14, 2025

(30) Foreign Application Priority Data
Oct. 30, 2024 (KR) 10-2024-0150873

(51) Int. Cl. B60T 13/74; B60T 8/171; B60T 8/172; B60T 13/14; B60T 13/68

(52) U.S. Cl. CPC B60T 13/745; B60T 8/171; B60T 8/172; B60T 13/142; B60T 13/148; B60T 13/686; B60T 2270/402

(57) ABSTRACT

Disclosed herein is an electric brake system including an auxiliary brake module including a first pump configured to discharge a pressing medium to a first wheel cylinder, a motor configured to drive the first pump, and a first auxiliary supply valve configured to control the pressing medium to be supplied to the first pump, and a control circuit configured to control a hydraulic pressure control unit to block flow paths connecting the hydraulic pressure control unit to a hydraulic pressure supply device, wheel cylinders excluding the first wheel cylinder, and an integrated master cylinder, perform driving control of the motor in a blocked state of the flow path, and diagnose a state of at least one of the first pump, the motor, or the first auxiliary supply valve based on monitoring of a pressure acquired during the driving control of the motor.

This application claims the benefit of Korean Patent Application No. 2024-0150873, filed on Oct. 30, 2024 in the Korean Intellectual Property Office, the disclosure of which is incorporated herein by reference.

### BACKGROUND

### 1. Field

The present invention relates to an electric brake system and a method of controlling the same.

### 2. Description of the Related Art

Vehicles are essentially provided with a brake system for braking, and various types of brake systems have been proposed for the safety of drivers and passengers.

Conventional brake systems mainly use a method of supplying a hydraulic pressure required for braking to wheel cylinders using a mechanically connected booster when a driver steps on a brake pedal. However, as the market demand for implementing various braking functions in detail in response to operating environments of a vehicle increases, electric brake systems, which receive the braking intention of a driver as an electrical signal from a pedal displacement sensor for detecting the displacement of a brake pedal when the driver steps on the brake pedal and accordingly operate a hydraulic pressure supply device to supply a hydraulic pressure required for braking to wheel cylinders, have recently become widespread.

Such an electric brake system receives a brake pedal operation or braking determination of the driver during autonomous driving of the vehicle as an electrical signal and accordingly electrically operates and controls the hydraulic pressure supply device to generate the hydraulic pressure required for braking and transmit the hydraulic pressure to the wheel cylinders.

Such an electric brake system and a method of controlling the same are electrically operated and controlled and can implement complex and diverse braking operations. However, when a technical problem occurs in electric components, the hydraulic pressure required for braking cannot be stably generated, which can threaten the safety of occupants of a vehicle.

Accordingly, the electric brake system enters an abnormal operation mode when one component fails or is in an uncontrollable state, and at this time, a mechanism in which the brake pedal operation of the driver needs to be directly linked to the wheel cylinders.

In addition, there is a need for a method of implementing stable braking of the vehicle even before the driver operates the brake pedal after the electric brake system enters the abnormal operation mode.

In addition, there is a need for a method of performing active braking, such as an anti-lock brake system (ABS) mode of a vehicle and the like so that the vehicle can perform stable braking and stable behavior even in the abnormal operation mode of the electric brake system.

### SUMMARY

Therefore, it is an aspect of the present disclosure to provide an electric brake system with improved braking performance and operation reliability, and a method of controlling the same.

For example, the electric brake system and the method of controlling the same may provide a failure diagnosis technology of the electric brake system.

Additional aspects of the disclosure will be set forth in part in the description which follows and, in part, will be obvious from the description, or may be learned by practice of the disclosure.

In accordance with one aspect of the present disclosure, an electric brake system includes a hydraulic pressure control unit provided between a hydraulic pressure supply device configured to generate a hydraulic pressure of a pressing medium and a plurality of wheel cylinders to transfer the hydraulic pressure generated from the hydraulic pressure supply device to the plurality of wheel cylinders, a pressure sensor configured to detect a pressure of the hydraulic pressure control unit, an auxiliary brake module including a first pump configured to press the pressing medium and discharge the pressing medium to a first wheel cylinder among the plurality of wheel cylinders, a motor configured to drive the first pump, and a first auxiliary supply valve configured to control the pressing medium to be supplied to the first pump, and a control circuit electrically connected to the hydraulic pressure control unit, the pressure sensor, and the auxiliary brake module, wherein the control circuit may be configured to control the hydraulic pressure control unit to block flow paths connecting the hydraulic pressure control unit to the hydraulic pressure supply device, wheel cylinders excluding the first wheel cylinder among the plurality of wheel cylinders, and an integrated master cylinder, perform driving control of the motor in a blocked state of the flow path, and diagnose a state of at least one of the first pump, the motor, or the first auxiliary supply valve based on monitoring of a pressure acquired during the driving control of the motor.

The control circuit may be configured to perform first driving control of the motor based on the blocked flow path and a closed state of the first auxiliary supply valve, diagnose a state of the first auxiliary supply valve based on monitoring of a pressure acquired through an output signal of the pressure sensor during the first driving control of the motor, perform second driving control of the motor based on the blocked flow path and an open state of the first auxiliary supply valve, and diagnose states of the first pump and the motor based on the monitoring of the pressure acquired through the output signal of the pressure sensor during the second driving control of the motor.

The control circuit may be configured to determine that the first auxiliary supply valve is in an abnormal state when the pressure acquired through the output signal of the pressure sensor is increased during the first driving control of the motor, and determine that the first auxiliary supply valve is in a normal state when the pressure acquired through the output signal of the pressure sensor is not increased during the first driving control of the motor.

The control circuit may be configured to determine that the first pump and the motor are in a normal state when the pressure acquired through the output signal of the pressure sensor is increased during the second driving control of the motor, and determine that at least one of the first pump or the motor is in an abnormal state when the pressure acquired through the output signal of the pressure sensor is not increased during the second driving control of the motor.

The auxiliary brake module may further include a first auxiliary flow path configured to transfer the pressing medium pressed by the first pump to the first wheel cylinder, and a first pressure control valve configured to control a pressure of the first auxiliary flow path, and the control circuit may control the first pressure control valve to be in a closed state or an open state.

The electric brake system may further include a dump valve provided on a dump flow path connecting the hydraulic pressure supply device to a reservoir to control a flow of the pressing medium, wherein the control circuit may be configured to after releasing the pressure of the electric brake system, control a valve provided on a flow path connecting the hydraulic pressure control unit to the hydraulic pressure supply device to block the flow path connecting the hydraulic pressure control unit to the hydraulic pressure supply device, control the dump valve to be in a closed state, and control the first pressure control valve to be in an open state, perform third driving control of the motor based on the blocked flow path connecting the hydraulic pressure control unit to the hydraulic pressure supply device, the closed state of the dump valve, and the open state of the first pressure control valve, and diagnose a state of the first pressure control valve based on monitoring of a pressure acquired through an output signal of the pressure sensor during the third driving control of the motor.

The control circuit may be configured to determine that the first pressure control valve is in an abnormal state when the pressure acquired through the output signal of the pressure sensor is increased during the third driving control of the motor, and determine that the first pressure control valve is in a normal state when the pressure acquired through the output signal of the pressure sensor is not increased during the third driving control of the motor.

To release the pressure of the electric brake system, the control circuit may control the motor to be in an inactive state, control the first auxiliary supply unit to be in an open state, control a valve provided on the flow path connecting the hydraulic pressure control unit to the hydraulic pressure supply device to open the flow path connecting the hydraulic pressure control unit to the hydraulic pressure supply device, and control the dump valve to be in an open state.

The auxiliary brake module may further include a second pump configured to press the pressing medium based on driving of the motor and discharge the pressing medium to a second wheel cylinder among the plurality of wheel cylinders, and a second auxiliary supply valve configured to control the pressing medium to be supplied to the second pump, and the control circuit may be configured to control the hydraulic pressure control unit to connect a connection flow path, which connects an integrated master cylinder to the second wheel cylinder, to the hydraulic pressure control unit and block flow paths connecting wheel cylinders excluding the second wheel cylinder to the hydraulic pressure control unit, control a cut valve so that the cut valve provided on the connection flow path is in a closed state, control the driving of the motor based on a state of connection of the connection flow path, which connects the integrated master cylinder, to the second wheel cylinder, to the hydraulic pressure control unit and blocking of the flow paths connecting the wheel cylinders excluding the second wheel cylinder to the hydraulic pressure control unit and the closed state of the cut valve, and diagnose a state of at least one of the second pump, the motor, or the second auxiliary supply valve based on monitoring of a pressure acquired through an output signal of the pressure sensor during the driving control of the motor based on the state of connection of the connection flow path, which connects the integrated master cylinder, to the second wheel cylinder, to the hydraulic pressure control unit and blocking of the flow paths connecting the wheel cylinders excluding the second wheel cylinder to the hydraulic pressure control unit and the closed state of the cut valve.

The control circuit may be configured to perform fourth driving control of the motor based on the state of connection of the connection flow path, which connects the integrated master cylinder, to the second wheel cylinder, to the hydraulic pressure control unit and blocking of the flow paths connecting the wheel cylinders excluding the second wheel cylinder to the hydraulic pressure control unit, the closed state of the cut valve, and the closed state of the second auxiliary supply valve, diagnose a state of the second auxiliary supply valve based on the monitoring of the pressure acquired through the output signal of the pressure sensor during the fourth driving control of the motor, perform fifth driving control of the motor based on the state of connection of the connection flow path, which connects the integrated master cylinder, to the second wheel cylinder, to the hydraulic pressure control unit and blocking of the flow paths connecting the wheel cylinders excluding the second wheel cylinder to the hydraulic pressure control unit, the closed state of the cut valve, and the open state of the second auxiliary supply valve, and diagnose states of the second pump and the motor based on the monitoring of the pressure acquired through the output signal of the pressure sensor during the fifth driving control of the motor.

The control circuit may be configured to determine that the second auxiliary supply valve is in an abnormal state when the pressure acquired through the output signal of the pressure sensor is increased during the fourth driving control of the motor, and determine that the second auxiliary supply valve is in a normal state when the pressure acquired through the output signal of the pressure sensor is not increased during the fourth driving control of the motor.

The control circuit may be configured to determine that the second pump and the motor are in a normal state when the pressure acquired through the output signal of the pressure sensor is increased during the fifth driving control of the motor, and determine that at least one of the second pump or the motor is in an abnormal state when the pressure acquired through the output signal of the pressure sensor is not increased during the fifth driving control of the motor.

The electric brake system may further include a dump valve provided on a dump flow path connecting the hydraulic pressure supply device to a reservoir to control a flow of the pressing medium, wherein the auxiliary brake module may further include a second auxiliary flow path configured to transfer the pressing medium pressed by the second pump to the second wheel cylinder, and a second pressure control valve configured to control a pressure of the second auxiliary flow path, and the control circuit may control the second pressure control valve and the dump valve to be in a closed state or an open state.

The control circuit may be configured to, after releasing the pressure of the electric brake system, control the first pressure control valve and the second pressure control valve to be in a closed state and control the dump valve to be in an open state, perform sixth driving control of the motor based on the closed states of the first pressure control valve and the second pressure control valve and the open state of the dump valve, and diagnose a state of the second pressure control valve based on the monitoring of the pressure acquired through the output signal of the pressure sensor during the sixth driving control of the motor.

The control circuit may be configured to determine that the second pressure control valve is in an abnormal state when the pressure acquired through the output signal of the pressure sensor is increased during the sixth driving control of the motor, and determine that the second pressure control valve is in a normal state when the pressure acquired through the output signal of the pressure sensor is not increased during the sixth driving control of the motor.

To release the pressure of the electric brake system, the control circuit may control the motor to be in an inactive state, control the second auxiliary supply unit to be in an open state, control a valve provided on the flow path connecting the hydraulic pressure control unit to the hydraulic pressure supply device to open the flow path connecting the hydraulic pressure control unit to the hydraulic pressure supply device, control the dump valve to be in an open state, and control the first pressure control valve and the second pressure control valve to be in an open state.

In accordance with another aspect of the present disclosure, a method of controlling an electric brake system, which includes a hydraulic pressure control unit provided between a hydraulic pressure supply device configured to generate a hydraulic pressure of a pressing medium and a plurality of wheel cylinders to transfer the hydraulic pressure generated from the hydraulic pressure supply device to the plurality of wheel cylinders, a pressure sensor configured to detect a pressure of the hydraulic pressure control unit, and an auxiliary brake module including a first pump configured to press the pressing medium and discharge the pressing medium to a first wheel cylinder among the plurality of wheel cylinders, a motor configured to drive the first pump, and a first auxiliary supply valve configured to control the pressing medium to be supplied to the first pump, includes controlling the hydraulic pressure control unit to block flow paths connecting the hydraulic pressure control unit to the hydraulic pressure supply device, wheel cylinders excluding the first wheel cylinder among the plurality of wheel cylinders, and an integrated master cylinder, performing driving control of the motor in a blocked state of the flow path, and diagnosing a state of at least one of the first pump, the motor, or the first auxiliary supply valve based on monitoring of a pressure acquired during the driving control of the motor.

The performing of the driving control of the motor may include performing first driving control of the motor further based on a closed state of the first auxiliary supply valve and performing second driving control of the motor further based on an open state of the first auxiliary supply valve, and the diagnosing of the state of at least one of the first pump, the motor, or the first auxiliary supply valve may include diagnosing a state of the first auxiliary supply valve based on monitoring of a pressure acquired through an output signal of the pressure sensor during the first driving control of the motor, and diagnosing states of the first pump and the motor based on the monitoring of the pressure acquired through the output signal of the pressure sensor during the second driving control of the motor.

The auxiliary brake module may further include a first auxiliary flow path configured to transfer the pressing medium pressed by the pump to the first wheel cylinder, and a first pressure control valve configured to control a pressure of the first auxiliary flow path, and the electric brake system may further include a dump valve provided on a dump flow path connecting the hydraulic pressure supply device to a reservoir to control a flow of the pressing medium.

The method may further include, after releasing the pressure of the electric brake system, controlling a valve provided on a flow path connecting the hydraulic pressure control unit to the hydraulic pressure supply device to block the flow path connecting the hydraulic pressure control unit to the hydraulic pressure supply device, controlling the dump valve to be in a closed state, and controlling the first pressure control valve to be in an open state, performing third driving control of the motor based on the blocked flow path connecting the hydraulic pressure control unit to the hydraulic pressure supply device, the closed state of the dump valve, and the open state of the first pressure control valve, and diagnosing a state of the first pressure control valve based on monitoring of a pressure acquired through an output signal of the pressure sensor during the third driving control of the motor.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a hydraulic pressure circuit diagram illustrating an electric brake system according to one embodiment;

FIG. 2 is a block diagram illustrating a configuration of a control circuit of the electric brake system according to one embodiment;

FIG. 3 is a view for describing failure diagnosis of an auxiliary brake module according to one embodiment;

FIG. 4 is a view for describing the failure diagnosis of the auxiliary brake module according to one embodiment;

FIG. 5 is a flowchart of the control operation of the electric brake system according to one embodiment; and

FIG. 6 is a flowchart of the control operation of the electric brake system according to one embodiment.

### DETAILED DESCRIPTION

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

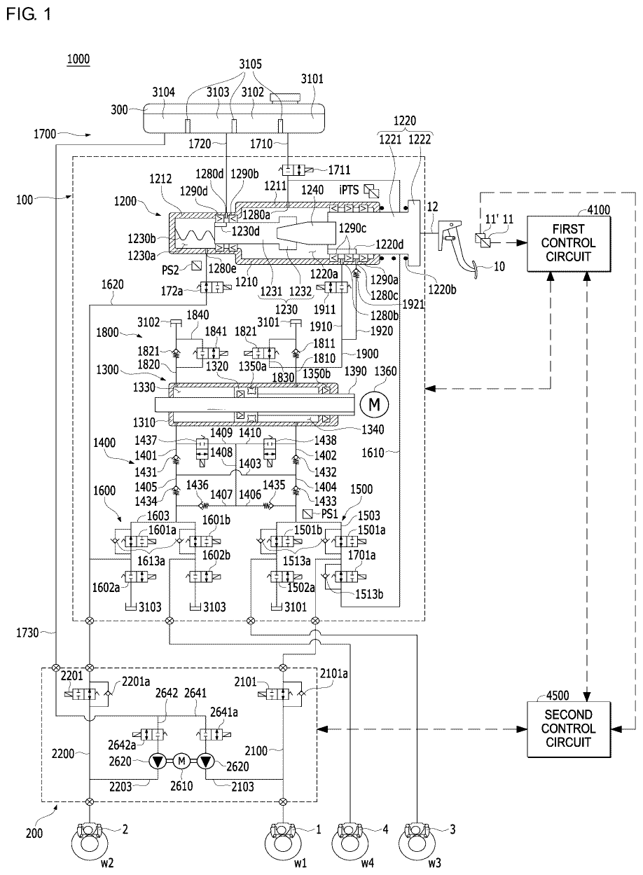

FIG. 1 is a hydraulic pressure circuit diagram illustrating an electric brake system according to one embodiment.

Referring to FIG. 1, an electric brake system 1000 may include a main brake module 100 (also referred to as an integrated dynamic brake (IDB) module) operated and controlled mechanically and/or electrically, an auxiliary brake module 200 that is provided between the main brake module 100 and a plurality of wheel cylinders 1, 2, 3, and 4 and operates when the main brake module 100 is inoperable, a reservoir 300 in which a pressing medium is stored, a first control circuit 4100 for controlling the main brake module 100, and a second control circuit 4500 for controlling the auxiliary brake module 200.

The main brake module 100 may include an integrated master cylinder 1200 for providing a reaction force according to a pedal effort of a brake pedal 10 to a driver and, at the same time, pressing and discharging the pressing medium accommodated therein, a hydraulic pressure supply device 1300 for receiving the braking intention of the driver as an electrical signal from a first pedal displacement sensor 11 for detecting the displacement of the brake pedal 10 and generating a hydraulic pressure of the pressing medium through a mechanical operation, a hydraulic pressure control unit 1400 for controlling the hydraulic pressure provided from the hydraulic pressure supply device 1300, reservoir flow paths 1710, 1720, and 1730 that hydraulically connect the reservoir 300 to the integrated master cylinder 1200 and hydraulically connect the reservoir 300 to the auxiliary brake module 200, a dump control unit 1800 provided between the hydraulic pressure supply device 1300 and the reservoir 300 to control a flow of the pressing medium, and an inspection flow path 1900 provided to connect the integrated master cylinder 1200 to the hydraulic pressure supply device 1300 to inspect whether leakage occurs in various components.

When the driver steps on the brake pedal 10 for a braking operation, the integrated master cylinder 1200 is provided to provide a reaction force thereto to provide a stable pedal feel to the driver and, at the same time, press and discharge the pressing medium received therein by the operation of the brake pedal 10.

In the integrated master cylinder 1200, a master cylinder for pressing and discharging the pressing medium accommodated therein by the pedal effort of the brake pedal 10 and a pedal simulator 1240 for providing a pedal feel to the driver may be disposed coaxially within one cylinder body 1210.

The mastery cylinder of the integrated master cylinder 1200 may include the cylinder body 1210 forming a chamber therein, a first master chamber 1220a formed at an inlet of the cylinder body 1210 to which the brake pedal 10 is connected, a first master piston 122 provided in the first master chamber 1220a, connected to the brake pedal 10, and provided to be displaced by the operation of the brake pedal 10, a second master chamber 1230a formed an inner side than or in front of (left side based on FIG. 1) the first master chamber 1220a, and a second master piston 123 provided in the second master chamber 1230a and provided to be displaced by the displacement of the first master piston 1220 or a hydraulic pressure of the pressing medium accommodated in the first master chamber 1220a.

The pedal simulator 1240 may be disposed between the first master piston 1220 and the second master piston 1230 to provide a pedal feel through an elastic restoring force generated upon compression.

The first master chamber 1220a and the second master chamber 1230a may be formed sequentially inward (left side based on FIG. 1) from the brake pedal 10 (right side based on FIG. 1) on the cylinder body 1210 of the integrated master cylinder 1200. In addition, the first master piston 1220 and the second master piston 1230 are provided in the first master chamber 1220a and the second master chamber 1230a, respectively, to generate a hydraulic pressure or a negative pressure in the pressing medium accommodated in each chamber according to the forward movement and the backward movement.

The cylinder body 1210 may include a large diameter portion 1211 having the first master chamber 1220a formed therein and having a relatively large inner diameter, and a small diameter portion 1212 having the second master chamber 1230a formed therein and having a relatively smaller inner diameter than the large diameter portion 1211. The large diameter portion 1211 and the small diameter portion 1212 of the cylinder body 1210 may be formed integrally.

The first master chamber 1220a may be formed inside the large diameter portion 1211 that is formed in the front or rear (right side based on FIG. 1) of the cylinder body 1210, and the first master piston 1220 connected to the brake pedal 10 via an input rod 12 may be accommodated in the first master chamber 1220a to reciprocate.

The pressing medium may be introduced into and discharged from the first master chamber 1220a through a first hydraulic pressure port 1280a, a second hydraulic pressure port 1280b, and a third hydraulic pressure port 1280c.

The first hydraulic pressure port 1280a may be connected to the first reservoir flow path 1710 so that the pressing medium flows into the first master chamber 1220a from the reservoir 300 or the pressing medium accommodated in the first master chamber 1220a is discharged to the reservoir 300.

Through the second hydraulic pressure port 1280b and the third hydraulic pressure port 1280c, the first master chamber 1220a may be connected to first and second branch flow paths 1910 and 1920 of an inspection flow path 1900 to be described below, respectively, so that the pressing medium accommodated in the first master chamber 1220a is discharged toward the inspection flow path 1900 or the pressing medium is introduced into the first master chamber 1220a from the inspection flow path 1900.

The first master piston 1220 of the integrated master cylinder 1200 may be provided to be accommodated in the first master chamber 1220a and move forward (leftward based on FIG. 1) to press the pressing medium accommodated in the first master chamber 1220a to generate a hydraulic pressure or move backward (rightward based on FIG. 1) to generate a negative pressure inside the first master chamber 1220a. The first master piston 1220 may include a first body 1221 formed in a cylindrical shape to be in close contact with an inner circumferential surface of the first master chamber 1220a, and a first flange 1222 which is formed to radially extend at a rear end (right end portion based on FIG. 1) of the first body 1221 and to which the input rod 12 is connected. The first master piston 1220 may be elastically supported by a first piston spring 1220b, and the first piston spring 1220b may be provided to have one end supported by a front surface (left side based on FIG. 1) of the first flange 1222 and the other end supported by an outer surface of the cylinder body 1210.

The first master piston 1220 is provided with a first cut-off hole 1220d that communicates with the first master chamber 1220a and at the same time communicates with the third hydraulic pressure port 1280c in a non-operating state, that is, in a ready state before displacement occurs. In addition, a first sealing member 1290a for sealing the first master chamber 1220a from the outside may be provided between an outer circumferential surface of the first master piston 1220 and the cylinder body 1210. The first sealing member 1290a may be provided to be seated in an accommodating groove recessed in an inner circumferential surface of the cylinder body 1210, may be in contact with the outer circumferential surface of the first master piston 1220, can prevent the pressing medium accommodated in the first master chamber 1220a by the first sealing member 1290a from leaking externally, and at the same time prevent external foreign substances from flowing into the first master chamber 1220a. The first sealing member 1290a may be provided at an outermost side on the inner circumferential surface of the cylinder body 1210, that is, at the rear (right side based on FIG. 1) of the third hydraulic pressure port 1280c.

Third sealing members 1290c that block a flow of the pressing medium from flowing into the first master chamber 1220a from the first branch flow path 1910 connected to the third hydraulic pressure port 1280c may be provided between the outer circumferential surface of the first master piston 1220 and the cylinder body 1210. The third sealing members 1290c may each be seated in accommodating grooves formed in the front of the third hydraulic pressure port 1280c on the inner circumferential surface of the cylinder body 1210 to be in contact with the outer circumferential surface of the first master piston 1220. The third sealing member 1290c may be provided in front (left side based on FIG. 1) of the first sealing member 1290a and may allow the pressing medium accommodated in the first master chamber 1220a to flow to the first branch flow path 1910 through the third hydraulic pressure port 1280c but block a flow of the pressing medium from flowing into the first master chamber 1220a from the first branch flow path 1910.

The second master chamber 1230a may be formed inside the small diameter portion 1212 that is formed inside or in front (left side based on FIG. 1) of the cylinder body 1210, and the second master piston 1230 may be accommodated in the second master chamber 1230a to reciprocate.

The pressing medium may be introduced into and discharged from the second master chamber 1230a through a fourth hydraulic pressure port 1280d and a fifth hydraulic pressure port 1280e. The fourth hydraulic pressure port 1280d may be connected to the second reservoir flow path 1720 so that the pressing medium accommodated in the reservoir 300 flows into the second master chamber 1230a. In addition, the fifth hydraulic pressure port 1280e may be connected to a second connection flow path 1620 to be described below so that the pressing medium accommodated in the second master chamber 1230a is discharged toward the second connection flow path 1620, and conversely, the pressing medium flows into the second master chamber 1230a from the second connection flow path 1620.

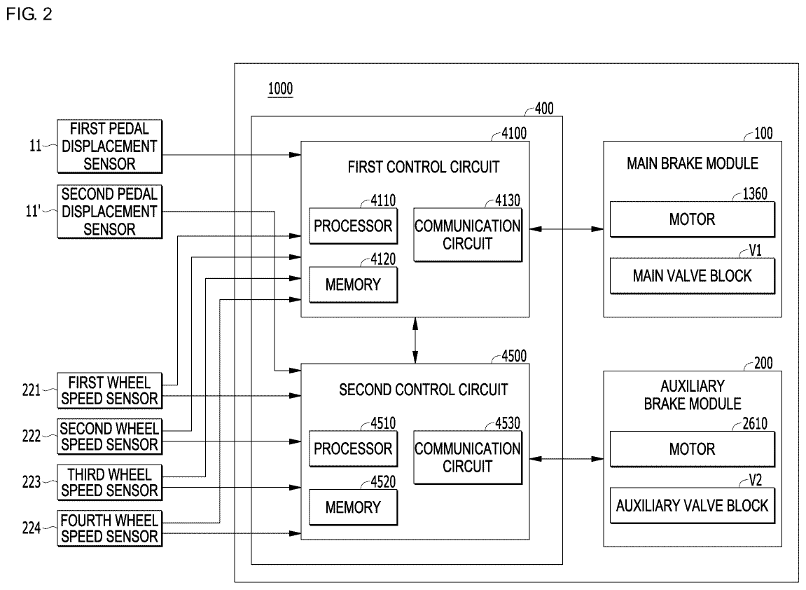

The second master piston 1230 may be provided to be accommodated in the second master chamber 1230a, move forward to generate a hydraulic pressure of the pressing medium accommodated in the second master chamber 1230a, and move backward to generate a negative pressure in the second master chamber 1230a. The second master piston 1230 may include a second body 1231 formed in a cylindrical shape to be in close contact with an inner circumferential surface of the second master chamber 1230a, and a second flange 1232 formed to radially extend at a rear end (right end portion based on FIG. 2) of the second body 1231 and disposed inside the first master chamber 1220a. A diameter of the second flange 1232 may be formed to be greater than an inner circumferential diameter of the second master chamber 1230a. The second master piston 1230 may be elastically supported by a second piston spring (not illustrated), and the second piston spring may be provided to have one end supported by a front surface (left surface based on FIG. 2) of the second body 1231 and the other end supported by an inner surface of the cylinder body 1210.

A second sealing member 1290b that seals the first master chamber 1220a with respect to the second master chamber 1230a may be provided between an outer circumferential surface of the second master piston 1230 and the cylinder body 1210. The second sealing member 1290b may be provided to be seated in an accommodating groove recessed in the inner circumferential surface of the cylinder body 1210 to be in contact with the outer circumferential surface of the second master piston 1230 and can prevent leakage of the pressing medium accommodated in the first master chamber 1220a by the second sealing member 1290b.

The second master piston 1230 is provided with a second cut-off hole 1230d that communicates with the second master chamber 1230a and at the same time communicates with the fourth hydraulic pressure port 1280d and the second reservoir flow path 1720 in a non-operating state, that is, in a ready state before displacement occurs. In addition, a fourth sealing member 1290d that blocks the pressing medium discharged from the second master chamber 1230a from flowing to the second reservoir flow path 1720 connected to the fourth hydraulic pressure port 1280d may be provided between the outer circumferential surface of the second master piston 1230 and the cylinder body 1210. The fourth sealing member 1290d may be seated in an accommodating groove recessed in the front (left side based on FIG. 1) of the fourth hydraulic pressure port 1280d on the inner circumferential surface of the cylinder body 1210 to be in contact with the outer circumferential surface of the second master piston 1230. The fourth sealing member 1290d may be provided in front of the second sealing member 1290b (left side based on FIG. 1) and may allow the pressing medium flowing to flow into the second master chamber 1230a from the second reservoir flow path 1720 connected to the fourth hydraulic pressure port 1280d but block the pressing medium discharged from the second master chamber 1230a from flowing to the fourth hydraulic pressure port 1280d and the second reservoir flow path 1720.

The integrated master cylinder 1200 can secure safety when a component fails by independently providing the first master chamber 1220a and the second master chamber 1230a. For example, the first master chamber 1220a may be connected to the wheel cylinders 1, 2, 3, and 4 through the inspection flow path 1900, the hydraulic pressure supply device 1300, the hydraulic pressure control unit 1400, and/or the auxiliary brake module 200, and the second master chamber 1230a may be connected to two wheel cylinders 1 and 2 through the second connection flow path 1620 to be described below, and thus the vehicle may be braked even when a problem such as leakage occurs in one chamber.

The pedal simulator 1240 may be provided between the first master piston 1220 and the second master piston 1230 and provide the pedal feel of the brake pedal 10 to the driver by the elastic restoring force thereof.

The pedal simulator 1240 may be interposed between a front surface of the first master piston 1220 and a rear surface of the second master piston 1230 and formed of an elastic material such as compressible and expandable rubber. The pedal simulator 1240 may include a cylindrical body portion at least partially inserted into and supported by the front surface of the first master piston 1220, and a tapered portion at least partially inserted into and supported by a rear surface of the second master piston 1230 and having a diameter gradually decreasing forward (left side based on FIG. 1). At least parts of both ends of the pedal simulator 1240 may each be stably supported by being inserted into the first master piston 1220. Furthermore, a stable and familiar pedal feel may be provided to the driver by changing the elastic restoring force according to the degree of a pedal effort of the brake pedal 10 by the tapered portion.

The hydraulic pressure supply device 1300 is provided to receive the braking intention of the driver as an electrical signal from the first pedal displacement sensor 11 for detecting the displacement of the brake pedal 10 and generating the hydraulic pressure of the pressing medium through a mechanical operation.

The hydraulic pressure supply device 1300 may include a hydraulic pressure provision unit for providing pressures of the pressing media transmitted to the wheel cylinders 1, 2, 3, and 4, a motor 1360 for generating a rotational force by an electrical signal of the first pedal displacement sensor 11, and a power conversion unit (not illustrated) for converting a rotational motion into a linear motion of the motor 1360 and transmitting the linear motion to the hydraulic pressure provision unit.

The hydraulic pressure provision unit of the hydraulic pressure supply device 1300 includes a cylinder block 1310 in which the pressing medium is provided to be accommodatable, a hydraulic piston 1320 accommodated in the cylinder block 1310, pressure chambers 1330 and 1340 of which volumes are changed by the operation of the hydraulic piston 1320, and a driving shaft 1390 for transmitting power output from the power conversion unit to the hydraulic piston 1320.

The first pressure chamber 1330 may be provided at a front surface side (a left direction of the hydraulic piston 1320 based on FIG. 1) of the hydraulic piston 1320. The second pressure chamber 1340 may be provided at a rear surface side (a right direction of the hydraulic piston 1320 based on FIG. 2) of the hydraulic piston 1320. That is, the first pressure chamber 1330 may be partitioned by the cylinder block 1310 and a front surface of the hydraulic piston 1320 and provided to have a volume that varies depending on the forward and backward movement of the hydraulic piston 1320. The second pressure chamber 1340 may be partitioned by the cylinder block 1310 and a rear surface of the hydraulic piston 1320 and provided to have a volume that varies depending on the forward and backward movement of the hydraulic piston 1320. The first pressure chamber 1330 is connected to the first hydraulic pressure flow path 1401, which will be described below, through a communication hole formed in the cylinder block 1310, and the second pressure chamber 1340 is connected to the second hydraulic pressure flow path 1402 described below through a communication hole formed in the cylinder block 1310.

A sealing member may be provided between the hydraulic piston 1320 and the cylinder block 1310 to seal openings of the first and second pressure chambers 1330 and 1340 and the cylinder block 1310 so that the hydraulic pressures or negative pressures of the first and second pressure chambers 1330 and 1340 generated by the forward or backward movement of the hydraulic piston 1320 do not leak to the outside and may be transmitted to the hydraulic pressure control unit 1400 and the dump control unit 1800, which will be described below.

The motor 1360 is provided to generate a driving force of the hydraulic piston 1320 by an electric signal output from the first control circuit 4100. The motor 1360 may be provided with a stator and a rotor and thus rotate in a forward direction or a reverse direction to provide power for generating the displacement of the hydraulic piston 1320. A rotational angular speed and rotational angle of the motor 1360 may be precisely controlled by a motor control sensor (not illustrated). Since the motor 1360 is a well-known technology, detailed description thereof will be omitted.

The power conversion unit of the hydraulic pressure supply device 1300 is provided to convert the rotational force of the motor 1360 into a linear motion. For example, the power conversion unit may be provided in a structure including a worm shaft (not illustrated), a worm wheel (not illustrated), and a driving shaft 1390.

The worm shaft may be formed integrally with a rotational shaft of the motor 1360, and a worm may be formed on an outer circumferential surface of the worm shaft and coupled to be engaged with the worm wheel to rotate the worm wheel. The worm wheel may be connected to be engaged with the driving shaft 1390 to linearly move the driving shaft 1390, and the driving shaft 1390 may be connected to the hydraulic piston 1320 to operates integrally, and thus the hydraulic piston 1320 may slide in the cylinder block 1310.

Describing the above operations again, when the displacement of the brake pedal 10 is detected by the first pedal displacement sensor 11, the detected signal is transmitted to the first control circuit 4100, and the first control circuit 4100 drives the motor 1360 to rotate the worm shaft in one direction. The rotational force of the worm shaft may be transmitted to the driving shaft 1390 through the worm wheel, and the hydraulic piston 1320 connected to the driving shaft 1390 may move forward in the cylinder block 1310 to generate a hydraulic pressure in the pressure chamber 1330.

Conversely, when the pedal effort of the brake pedal 10 is released, the first control circuit 4100 drives the motor 1360 to rotate the worm shaft in an opposite direction. Accordingly, the worm wheel may also rotate in the opposite direction, and the hydraulic piston 1320 connected to the driving shaft 1390 may move backward in the cylinder block 1310 to generate a negative pressure in the pressure chamber 1330.

The hydraulic pressure supply device 1300 may be hydraulically connected to the reservoir 300 by the dump control unit 1800.

The hydraulic pressure control unit 1400 may be provided to control the flows of the pressing media toward each of the wheel cylinders 1, 2, 3, and 4 or the flow of the pressing medium collected in the hydraulic pressure supply device 1300 from each of the wheel cylinders 1, 2, 3, and 4. To this end, the hydraulic pressure control unit 1400 may include a plurality of flow paths and a plurality of valves capable of allowing or blocking the flow of the pressing medium in the plurality of flow paths to smoothly control the flow or hydraulic pressure of the pressing medium. In addition, the hydraulic pressure control unit 1400 may include first and second hydraulic pressure circuits 1500 and 1600 for controlling the flows of the hydraulic pressures transmitted to the wheel cylinders 1, 2, 3, and 4 that perform braking of wheels w1, w2, w3, and w4 by the received hydraulic pressure of the pressing medium.

The hydraulic pressure control unit 1400 may include first to tenth hydraulic pressure flow paths 1401, 1402, 1403, 1404, 1405, 1406, 1407, 1408, 1409, and 1410. The first hydraulic pressure flow path 1401 may be provided to communicate with the first pressure chamber 1330, and the second hydraulic pressure flow path 1402 may be provided to communicate with the second pressure chamber 1340.

The first hydraulic pressure flow path 1401 and the second hydraulic pressure flow path 1402 may be provided to be merged with a third hydraulic pressure flow path 1403 and then re-branched into a fourth hydraulic pressure flow path 1404 connected to the first hydraulic pressure circuit 1500, and a fifth hydraulic pressure flow path 1405 connected to the second hydraulic pressure circuit 1600.

The sixth hydraulic pressure flow path 1406 may be provided to communicate with the first hydraulic pressure circuit 1500, and the seventh hydraulic pressure flow path 1407 may be provided to communicate with the second hydraulic pressure circuit 1600. The sixth hydraulic pressure flow path 1406 and the seventh hydraulic pressure flow path 1407 may be merged with the eighth hydraulic pressure flow path 1408 and then re-branched into the ninth hydraulic pressure flow path 1409 that communicates with the first pressure chamber 1330 and the tenth hydraulic pressure flow path 1410 that communicates with the second pressure chamber 1340.

The first hydraulic pressure flow path 1401 may be provided with a first valve 1431 that controls the flow of the pressing medium. The first valve 1431 may be provided as a check valve that allows the flow of the pressing medium discharged from the first pressure chamber 1330 but blocks the pressing medium from flowing in the opposite direction. In addition, the second hydraulic pressure flow path 1402 may be provided with a second valve 1432 that controls the flow of the pressing medium, and the second valve 1432 may be provided as a check valve that allows the flow of the pressing medium discharged from the second pressure chamber 1340 and blocks the pressing medium from flowing in the opposite direction.

The fourth hydraulic pressure flow path 1404 is provided to be branched from the third hydraulic pressure flow path 1403, at which the first hydraulic pressure flow path 1401 and the second hydraulic pressure flow path 1402 are merged, and connected to the first hydraulic pressure circuit 1510. The third hydraulic pressure flow path 1403 may be provided with a third valve 1433 that controls the flow of the pressing medium. The third valve 1433 may be provided as a check valve that allows the pressing medium to flow only from the third hydraulic pressure flow path 1403 to the first hydraulic pressure circuit 1500 and blocks the pressing medium from flowing in the opposite direction.

The fifth hydraulic pressure flow path 1405 is provided to be branched from the third hydraulic pressure flow path 1403, at which the first hydraulic pressure flow path 1401 and the second hydraulic pressure flow path 1402 are merged, and connected to the second hydraulic pressure circuit 1600. The fifth hydraulic pressure flow path 1405 may be provided with a fourth valve 1434 that controls the flow of the pressing medium. The fourth valve 1434 may be provided as a check valve that allows the pressing medium to flow only from the third hydraulic pressure flow path 1403 to the second hydraulic pressure circuit 1600 and blocks the pressing medium from flowing in the opposite direction.

The sixth hydraulic pressure flow path 1406 is provided to communicate with the first hydraulic pressure circuit 1500, and the seventh hydraulic pressure flow path 1407 is provided to communicate with the second hydraulic pressure circuit 1600 and to be merged with the eighth hydraulic pressure flow path 1408. The sixth hydraulic pressure flow path 1406 may be provided with a fifth valve 1435 that controls the flow of the pressing medium. The fifth valve 1435 may be provided as a check valve that allows the flow of the pressing medium discharged from the first hydraulic pressure circuit 1500 but blocks the pressing medium from flowing in the opposite direction. In addition, the seventh hydraulic pressure flow path 1407 may be provided with a sixth valve 1436 that controls the flow of the pressing medium. The sixth valve 1436 may be provided as a check valve that allows only the flow of the pressing medium discharged from the second hydraulic pressure circuit 1600 and blocks the pressing medium from flowing in the opposite direction.

The ninth hydraulic pressure flow path 1409 is provided to be branched from the eighth hydraulic pressure flow path 1408, at which the sixth hydraulic pressure flow path 1406 and the seventh hydraulic pressure flow path 1407 are merged, and connected to the first pressure chamber 1330. The ninth hydraulic pressure flow path 1409 may be provided with a seventh valve 1437 that controls the flow of the pressing medium. The seventh valve 1437 may be provided as a two-way control valve that controls the flow of the pressing medium transmitted along the ninth hydraulic pressure flow path 1409. The seventh valve 1437 may be provided as a normal closed type solenoid valve.

The tenth hydraulic pressure flow path 1410 is provided to be branched from the eighth hydraulic pressure flow path 1408, at which the sixth hydraulic pressure flow path 1406 and the seventh hydraulic pressure flow path 1407 are merged, and connected to the second pressure chamber 1340. The tenth hydraulic pressure flow path 1410 may be provided with an eighth valve 1438 that controls the flow of the pressing medium. The eighth valve 1438 may be provided as a bidirectional control valve that controls the flow of the pressing medium transmitted along the tenth hydraulic pressure flow path 1410. The eighth valve 1438 may be provided as a normal closed type solenoid valve.

According to the above-described plurality of hydraulic pressure flow paths and plurality of valves, the hydraulic pressure generated in the first pressure chamber 1330 by the forward movement of the hydraulic piston 1320 may be transmitted to the first hydraulic pressure circuit 1500 sequentially through the first hydraulic pressure flow path 1401, the third hydraulic pressure flow path 1403, and the fourth hydraulic pressure flow path 1404 and may be transmitted to the second hydraulic pressure circuit 1600 sequentially through the first hydraulic pressure flow path 1401 and the fifth hydraulic pressure flow path 1405. In addition, the hydraulic pressure generated in the second pressure chamber 1340 by the backward movement of the hydraulic piston 1320 may be transmitted to the first hydraulic pressure circuit 1500 sequentially through the second hydraulic pressure flow path 1402 and the fourth hydraulic pressure flow path 1404 and may be transmitted to the second hydraulic pressure circuit 1600 sequentially through the second hydraulic pressure flow path 1402, the third hydraulic pressure flow path 1403, and the fifth hydraulic pressure flow path 1405.

Conversely, the negative pressure generated in the first pressure chamber 1330 by the backward movement of the hydraulic piston 1320 may cause the pressing medium provided to the first hydraulic pressure circuit 1510 to be collected in the first pressure chamber 1330 sequentially through the sixth hydraulic pressure flow path 1406, the eighth hydraulic pressure flow path 1408, and the ninth hydraulic pressure flow path 1409, and cause the pressing medium provided to the second hydraulic pressure circuit 1600 to be collected in the first pressure chamber 1330 sequentially through the seventh hydraulic pressure flow path 1407, the eighth hydraulic pressure flow path 1408, and the ninth hydraulic pressure flow path 1409. In addition, the negative pressure generated in the second pressure chamber 1340 by the forward movement of the hydraulic piston 1320 may cause the pressing medium provided to the first hydraulic pressure circuit 1500 to be collected in the first pressure chamber 1340 sequentially through the sixth hydraulic pressure flow path 1406, the eighth hydraulic pressure flow path 1408, and the tenth hydraulic pressure flow path 1410, and the pressing medium provided to the second hydraulic pressure circuit 1600 to be collected in the second pressure chamber 1340 sequentially through the seventh hydraulic pressure flow path 1407, the eighth hydraulic pressure flow path 1408, and the tenth hydraulic pressure flow path 1410.

The first hydraulic pressure circuit 1500 may adjust and control the hydraulic pressures applied to the first and third wheel cylinders 1 and 3, and the second hydraulic pressure circuit 1600 may adjust and control the hydraulic pressures applied to the second and fourth wheel cylinders 2 and 4.

The first hydraulic pressure circuit 1500 may include a first inlet valve 1501a disposed at an upstream side of the first wheel cylinder 1 to control the flow and hydraulic pressure of the pressing medium delivered to the first wheel cylinder 1, and a third inlet valve 1501b disposed at an upstream side of the third wheel cylinder 3 to control the flow and hydraulic pressure of the pressing medium transmitted to the third wheel cylinder 3. The first and third inlet valves 1501a and 1501b may be normal open type solenoid valves.

In addition, the first hydraulic pressure circuit 1500 may include first and third outlet valves 1701a and 1502a that control the flows of the pressing media discharged from the first and third wheel cylinders 1 and 3 to improve performance when the braking of the first and third wheel cylinders 1 and 3 is released.

The first outlet valve 1701a may be connected (or provided) to a first connection flow path 1610, which will be described below, corresponding to an outlet of the first wheel cylinder 1 to control the pressing medium to flow between the first wheel cylinder 1 and the integrated master cylinder 1200. For example, the first outlet valve 1701a may be provided as a normal open type solenoid valve.

The third outlet valve 1502a may be provided at the outlet of the third wheel cylinder 3 to control the pressing medium transmitted from the third wheel cylinder 3 to flow to the reservoir 300, more specifically, to flow to the first reservoir chamber 3101 of the reservoir 300. For example, the third outlet valve 1502a may be provided as a normal closed type solenoid valve.

The first hydraulic pressure circuit 1500 may include a check valve 1513a connected parallel to each of the first inlet valve 1501a and the third inlet valve 1501b. In addition, the first hydraulic pressure circuit 1500 may include a check valve 1513b connected parallel to the first outlet valve 1701a.

The check valve 1513a of the first inlet valve 1501a may be provided on a bypass flow path that connects the front and rear of the first inlet valve 1501a and may allow the pressing medium to flow only from the first wheel cylinder 1 to the hydraulic pressure supply device 1300 and block the pressing medium from flowing from the hydraulic pressure supply device 1300 to the first wheel cylinder 1.

The check valve 1513a of the third inlet valve 1501b may be provided on a bypass flow path that connects the front and rear of the third inlet valve 1501b and may allow the pressing medium to flow only from the third wheel cylinder 3 to the hydraulic pressure supply device 1300 and block the pressing medium from flowing from the hydraulic pressure supply device 1300 to the third wheel cylinder 3.

The check valve 1513b of the first outlet valve 1701a may be provided on a bypass path that connects the front and rear of the first outlet valve 1701a.

The first inlet valve 1501a, the third inlet valve 1501b, the first outlet valve 1701a, and the third outlet valve 1502a of the first hydraulic pressure circuit 1500 may be provided on a first hydraulic pressure circuit flow path 1503.

The first hydraulic pressure circuit flow path 1503 may be connected to or extends from the first connection flow path 1610. The flow hydraulic pressure circuit flow path 1503 may be merged with the fourth hydraulic pressure flow path 1404 of the hydraulic pressure control unit 1400 at the upstream sides of the first inlet valve 1501a and the third inlet valve 1501b. The first hydraulic pressure circuit flow path 1503 may be connected to the first connection flow path 1610 connected to a downstream of the first outlet valve 1701a through the first outlet valve 1701a. The first hydraulic pressure circuit flow path 1503 may be branched at the downstream of the first inlet valve 1501a and the upstream side of the first outlet valve 1701a and connected to the first wheel cylinder 1. The first hydraulic pressure circuit flow path 1503 may be branched at the downstream of the third inlet valve 1501b and the upstream side of the third outlet valve 1502a and connected to the third wheel cylinder 3.

The second hydraulic pressure circuit 1600 may include a second inlet valve 1601a disposed at an upstream side of the second wheel cylinder 2 to control the flow and hydraulic pressure of the pressing medium delivered to the second wheel cylinder 2, and a fourth inlet valve 1601b disposed at an upstream side of the fourth wheel cylinder 4 to control the flow and hydraulic pressure of the pressing medium transmitted to the fourth wheel cylinder 4. The second and fourth inlet valves 1601a and 1601b may be normal open type solenoid valves.

The second hydraulic pressure circuit 1600 may include second and fourth outlet valves 1602a and 1602b that control the flows of the pressing media discharged from the second and fourth wheel cylinders 2 and 4 to improve performance when the braking of the second and fourth wheel cylinders 2 and 4 is released.

The second outlet valve 1602a may be provided at an outlet of the second wheel cylinder 2 to control the pressing medium transmitted from the second wheel cylinder 2 to flow to the reservoir 300, more specifically, to the third reservoir chamber 3103 of the reservoir 300. For example, the second outlet valve 1602a may be provided as a normal closed type solenoid valve.

The fourth outlet valve 1602b may be provided at an outlet of the fourth wheel cylinder 4 to control the pressing medium transmitted from the fourth wheel cylinder 4 to flow to the reservoir 300, more specifically, to the third reservoir chamber 3103 of the reservoir 300. For example, the fourth outlet valve 1602b may be provided as a normal closed type solenoid valve.

The second hydraulic pressure circuit 1600 may include a check valve 1613a connected parallel to each of the second inlet valve 1601a and the fourth inlet valve 1601b.

The check valve 1613a of the second inlet valve 1601a may be provided on a bypass flow path that connects the front and rear of the second inlet valve 1601a and may allow the pressing medium to flow only from the second wheel cylinder 2 to the hydraulic pressure supply device 1300 and block the pressing medium from flowing from the hydraulic pressure supply device 1300 to the second wheel cylinder 2.

The check valve 1613a of the fourth inlet valve 1601b may be provided on a bypass flow path that connects the front and rear of the fourth inlet valve 1601b and may allow the pressing medium to flow only from the fourth wheel cylinder 4 to the hydraulic pressure supply device 1300 and block the pressing medium from flowing from the hydraulic pressure supply device 1300 to the fourth wheel cylinder 4.

The second inlet valve 1601a, the fourth inlet valve 1601b, the second outlet valve 1602a, and the fourth outlet valve 1602b may be provided on the second hydraulic pressure circuit flow path 1603.

The second hydraulic pressure circuit flow path 1603 may be branched from the second connection flow path 1620 or connected to the second connection flow path 1620. The second hydraulic pressure circuit flow path 1603 may be branched at the downstream of the second inlet valve 1601a and the upstream side of the second outlet valve 1602a and connected to the second wheel cylinder 2. The second hydraulic pressure circuit flow path 1603 may be merged with the fifth hydraulic pressure flow path 1405 of the hydraulic pressure control unit 1400 at the upstream sides of the second inlet valve 1601a and the fourth inlet valve 1601b. The second hydraulic pressure circuit flow path 1603 may be branched between the fourth inlet valve 1601b and the fourth outlet valve 1602b and connected to the fourth wheel cylinder 4.

The first connection flow path 1610 of the main brake module 100 may be provided to connect the first master chamber 1220a of the integrated master cylinder 1200 to the first hydraulic pressure circuit 1500, and the second connection flow path 1620 may be provided to connect the second master chamber 1230a of the integrated master cylinder 1200 to the second hydraulic pressure circuit 1600.

The first connection flow path 1610 may be provided to connect an outlet of the simulator valve 1711 provided on the first reservoir flow path 1710, which will be described below, to the first wheel cylinder 1. For example, the first connection flow path 1610 may communicate with the first wheel cylinder 1 through the first outlet valve 1701a and the auxiliary brake module 200 so that the outlet of the simulator valve 1711 provided on the first reservoir flow path 1710 and the first wheel cylinder 1 are connected.

The second connection flow path 1620 may be provided to connect the fifth hydraulic pressure port 1280e to the second wheel cylinder 2. For example, the second connection flow path 1620 may communicate with the second wheel cylinder 2 through the auxiliary brake module 200 so that the fifth hydraulic pressure port 1280e and the second wheel cylinder 2 are connected.

A cut valve 172a that controls a bidirectional flow of the pressing medium may be provided on the second connection flow path 1620. For example, the cut valve 172a may be provided as a normal open type solenoid valve.

The reservoir flow path 1700 may be provided to connect the integrated master cylinder 1200 to the reservoir 300.

The reservoir flow path 1700 may include the first reservoir flow path 1710 that connects the first master chamber 1220a to the first reservoir chamber 3101 of the reservoir 300, the second reservoir flow path 1720 that connects the second master chamber 1230a to the third reservoir chamber 3103 of the reservoir 300. In addition, the reservoir flow path 1700 may include the third reservoir flow path 1730 that connects the auxiliary brake module 200 to the fourth reservoir chamber 3104 of the reservoir 300.

One end of the first reservoir flow path 1710 may communicate with the first master chamber 1220a by the first hydraulic pressure port 1280a of the integrated master cylinder 1200, and the other end may communicate with the first reservoir chamber 3101 of the reservoir 300. The simulator valve 1711 may be provided on the first reservoir flow path 1710, and thus the flow of the pressing medium between the reservoir 300 and the first master chamber 1220a through the first reservoir flow path 1710 may be controlled.

One end of the second reservoir flow path 1720 may communicate with the second master chamber 1230a by the fourth hydraulic pressure port 1280d of the integrated master cylinder 1200, and the other end may communicate with the reservoir 300.

One end of the third reservoir flow path 1730 may be connected to auxiliary supply flow paths 2641 and 2642 connected to a pair of pumps 2620, which will be described below, of the auxiliary brake module 200.

The dump control unit 1800 may include at least one flow path and at least one valve to control the pressing medium to flow between the hydraulic pressure supply device 1300 and the reservoir 300.

The dump control unit 1800 may include a first dump control unit that controls a pressing medium to flow between the second pressure chamber 1340 and the first reservoir chamber 3101 of the reservoir 300, and a second dump control unit that controls a pressing medium to flow between the first pressure chamber 1330 and the second reservoir chamber 3102 of the reservoir 300.

The first dump control unit may include a first dump flow path 1810 that connects the second pressure chamber 1340 to the reservoir 300, and a first bypass flow path 1830 branched from and then remerged with the first dump flow path 1810. The second dump control unit may include a second dump flow path 1820 that connects the first pressure chamber 1330 to the reservoir 300, and a second bypass flow path 1840 branched from and then remerged with the second dump flow path 1820.

A first dump check valve 1811 and a first dump valve 1831 that control the flow of the pressing medium may be provided on the first dump flow path 1810 and the first bypass flow path 1830, respectively. The first dump check valve 1811 may be provided to allow the pressing medium to flow only from the reservoir 300 to the first pressure chamber 1330 and block the pressing medium from flowing in an opposite direction. The first bypass flow path 1830 may be connected parallel to the first dump check valve 1811 on the first dump flow path 1810, and the first bypass flow path 1830 may be provided with the first dump valve 1831 that controls the pressing medium to flow between the first pressure chamber 1330 and the reservoir 300. That is, the first bypass flow path 1830 may be connected by bypassing a front end and a rear end of the first dump check valve 1811 on the first dump flow path 1810, and the first dump valve 1831 may be provided as a two-way solenoid valve that controls the pressing medium to flow between the first pressure chamber 1330 and the reservoir 300. The first dump valve 1831 may be provided as a normal open type solenoid valve.

A second dump check valve 1821 and a second dump valve 1841 that control the flow of the pressing medium may be provided on the second dump flow path 1820 and the second bypass flow path 1840, respectively. The second dump check valve 1821 may be provided to allow the pressing medium to flow only from the reservoir 300 to the first pressure chamber 1330 and block the pressing medium from flowing in an opposite direction. The second bypass flow path 1840 may be connected parallel to the second dump check valve 1821 on the second dump flow path 1820, and the second bypass flow path 1840 may be provided with the second dump valve 1841 that controls the pressing medium to flow between the first pressure chamber 1330 and the reservoir 300. That is, the second bypass flow path 1840 may be connected by bypassing a front end and a rear end of the second dump check valve 1821 on the second dump flow path 1820, and the second dump valve 1841 may be provided as a two-way solenoid valve that controls the pressing medium to flow between the first pressure chamber 1330 and the reservoir 300. The second dump valve 1841 may be provided as a normal closed type solenoid valve.

The inspection flow path 1900 is provided to connect the integrated master cylinder 1200 to the hydraulic pressure supply device 1300 and provided to inspect whether leakage occurs in various components mounted on the integrated master cylinder 1200 and the simulator valve 1711.

The inspection flow path 1900 may have one end connected to the second pressure chamber 1340 and the other end branched into the first branch flow path 1910 and the second branch flow path 1920 that are connected to the first master chamber 1220a through the second hydraulic pressure port 1280b and the third hydraulic pressure port 1280c, respectively.

For example, an inspection valve 1911 may be provided on the first branch flow path 1910 to control the pressing medium to bidirectionally flow between the first master chamber 1220a and the second pressure chamber 1340. A test check valve 1921 may be provided on the second branch flow path 1920 to allow the pressing medium to flow only from the first master chamber 1220a to the second pressure chamber 1340 and block the pressing medium from flowing in the opposite direction.

One end of the inspection flow path 1900 may be connected to the second pressure chamber 1340 via the first dump flow path 1810 as illustrated in FIG. 1 but may be directly connected to the second pressure chamber 1340, which differs from that in FIG. 1.

The main brake module 100 may further include a circuit pressure sensor PS1 for detecting the hydraulic pressure of the pressing medium provided by the hydraulic pressure supply device 1300 and a cylinder pressure sensor PS2 for detecting the hydraulic pressure of the second master chamber 1230a.

The circuit pressure sensor PS1 may be provided on the first hydraulic pressure circuit 1500 to detect the hydraulic pressure of the pressing medium generated and provided from the hydraulic pressure supply device 1300 and transmitted to the first hydraulic pressure circuit 1510 in the inspection mode. For example, the circuit pressure sensor PS1 may be provided on the fourth hydraulic pressure flow path 1404.

The cylinder pressure sensor PS2 may be provided between the second master chamber 1230a and the cut valve 172a on the second connection flow path 1620 to detect the hydraulic pressure of the pressing medium accommodated in the second master chamber 1230a. For example, a signal corresponding to pressure value information of the pressing medium detected by the circuit pressure sensor PS1 and the cylinder pressure sensor PS2 may be transmitted to the first control circuit 4100, and the first control circuit 4100 may compare a hydraulic pressure value detected by the circuit pressure sensor PS1 with a hydraulic pressure value detected by the cylinder pressure sensor PS2 and determine whether leakage occurs in the integrated master cylinder 1200 or the simulator valve 1711.

In addition, the main brake module 100 may further include a stroke sensor (not illustrated) for measuring the displacement of the hydraulic piston 1320 of the hydraulic pressure supply device 1300, and the stroke sensor may be used to inspect whether leakage occurs in the integrated master cylinder 1200 based on information on the displacement of the hydraulic piston 1320.

The auxiliary brake module 200 may operate upon receiving a braking request from an external controller while the main brake module 100 is inoperable and generate and provide the hydraulic pressure required for braking the first and second wheel cylinders 1 and 2.

The auxiliary brake module 200 may include a pair of pumps 2620 that presses a pressing medium, a motor 2610 for driving the pair of pumps 2620, a first auxiliary flow path 2103 for transmitting the pressing medium pressed by the pumps 2620 to the first wheel cylinder 1, a second auxiliary flow path 2203 for transmitting the pressing medium pressed by the pumps 2620 to the second wheel cylinder 2, a first auxiliary supply flow path 2641 and a second auxiliary supply flow path 2642 that are provided to supply the pressing medium to each of the pair of pumps 2620, a first auxiliary supply valve 2641a provided on the first auxiliary supply flow path 2641 to control the pressing medium to be supplied to the pump 2620, a second auxiliary supply valve 2641b provided on the second auxiliary supply flow path 2642 to control the pressing medium to be supplied to the pump 2620, a first auxiliary connection flow path 2100 hydraulically connected to the first connection flow path 1610, a second auxiliary connection flow path 2200 hydraulically connected to the second connection flow path 1620, a first pressure control valve 2101 provided in the first auxiliary connection flow path 2100 to adjust a pressure of the first auxiliary connection flow path 2100 and the first auxiliary supply flow path 2641, a second pressure control valve 2201 provided in the second auxiliary connection flow path 2200 to control a pressure of the second auxiliary connection flow path 2200 and the second auxiliary supply flow path 2642, a first check valve 2101a connected parallel to the first pressure control valve 2101, and a second check valve 2201a connected parallel to the second pressure control valve 2201.

The pair of pumps 2620 may press the pressing medium according to the reciprocating movement of a piston (not illustrated) provided in the motor 2610. The pump 2620 receives the pressing medium from the first auxiliary supply flow path 2641 hydraulically connected to the third reservoir flow path 1730 of the reservoir 300 and presses the pressing medium to the level of the hydraulic pressure required for braking by operating the motor 2610.

The pressing medium having the hydraulic pressure generated by one of the pair of pumps 2620 may be transmitted to the first wheel cylinder 1 by the first auxiliary flow path 2103 provided as an outlet flow path of the pump 2620. To this end, the first auxiliary flow path 2103 may have an inlet end portion connected to the outlet of the pump 2620 and an outlet end portion connected to the first wheel cylinder 1.

The pressing medium having the hydraulic pressure generated by the other of the pair of pumps 2620 may be transmitted to the second wheel cylinder 2 by the second auxiliary flow path 2203 provided as an outlet flow path of the pump 2620. To this end, the second auxiliary flow path 2203 may have an inlet end portion connected to the outlet of the pump 2620 and an outlet end portion connected to the second wheel cylinder 2.

The first auxiliary supply flow path 2641 may have one end portion connected to the inlet of the pump 2620 and connected to the first auxiliary flow path 2103. In addition, the other end portion of the first auxiliary supply flow path 2641 may be connected to the third reservoir flow path 1730.

The first auxiliary supply flow path 2641 is provided with a first auxiliary supply valve 2641a that controls the flow of the pressing medium supplied to the pump 2620. The first auxiliary supply valve 2641a may be provided as a normal closed type solenoid valve.

The second auxiliary supply flow path 2642 may have one end portion connected to the inlet of the pump 2620 and be connected to the second auxiliary flow path 2203. In addition, the other end portion of the second auxiliary supply flow path 2642 may be connected to the third reservoir flow path 1730. The other end portion of the second auxiliary supply flow path 2642 may be branched from the first auxiliary supply flow path 2641 or connected to the first auxiliary supply flow path 2641.

The second auxiliary supply flow path 2642 is provided with a second auxiliary supply valve 2642a that controls the flow of the pressing medium supplied to the pump 2620. The second auxiliary supply valve 2642a may be provided as a normal closed type solenoid valve.

The first auxiliary connection flow path 2100 may extend to the first connection flow path (1610) and may be referred to as a part of the first connection flow path 1610, that is, the first connection flow path 1610. In addition, the second auxiliary connection flow path 2200 may extend to the second connection flow path 1620 and may be referred to as a part of the second connection flow path 1620, that is, the second connection flow path 1620.

A first pressure control valve 2101 may be provided on the first auxiliary connection flow path 2100, and a second pressure control valve 2201 may be provided on the second auxiliary connection flow path 2200.

The first pressure control valve 2101 may adjust a blocking pressure according to an electrical signal (or a current) from the second control circuit 4500 to adjust a pressure of the first auxiliary connection flow path 2100 and the first auxiliary supply flow path 2103.

The second pressure control valve 2201 may adjust a blocking pressure according to an electrical signal (or a current) from the second control circuit 4500 to adjust a pressure of the second auxiliary connection flow path 2200 and the second auxiliary supply flow path 2203.

The first pressure control valve 2101 and the second pressure control valve 2201 may be normal open type solenoid valves.

The first check valve 2101a connected parallel to the first pressure control valve 2101 and the second check valve 2201a connected parallel to the second pressure control valve 2201 may allow the pressing medium to flow in one direction to prevent a backflow in an opposite direction and may be controlled according to an electrical signal from the second control circuit 4500.

The reservoir 300 may accommodate and store the pressing medium therein. The reservoir 300 may be hydraulically connected to at least one component of the main brake module 100 and at least one component of the auxiliary brake module 200.

The reservoir 300 may be provided by being partitioned into a plurality of chambers by bulkheads 3105.

The reservoir 300 may include a plurality of reservoir chambers 1101, 1102, 1103, and 1104, and the plurality of reservoir chambers 1101, 1102, 1103, and 1104 may be disposed in parallel in a row. For example, the first reservoir chamber 3101, the second reservoir chamber 3102, the third reservoir chamber 3103, and the fourth reservoir chamber 3104 may be disposed in parallel in a row from one side to the other side of the reservoir 300.

The first reservoir chamber 3101 may communicate with the first reservoir flow path 1710 and be connected to the integrated master cylinder 1200 and may supply the pressing medium to the first master chamber 1220a of the integrated master cylinder 1200 or receive the pressing medium from the first master chamber 1220a. In addition, the first reservoir chamber 3101 may be hydraulically connected to the dump control unit 1800 and the hydraulic pressure circuit 1510.

The second reservoir chamber 3102 may be hydraulically connected to the dump control unit 1800.

The third reservoir chamber 3103 may communicate with the second reservoir flow path 1720 and be connected to the integrated master cylinder 1200. For example, the third reservoir chamber 3103 may supply the pressing medium to the second master chamber 1230a of the integrated master cylinder 1200 or receive the pressing medium from the second master chamber 1230a through the second reservoir flow path 1720 and the fourth hydraulic pressure port 1280d of the integrated master cylinder 1200 connected to the second reservoir flow path 1720. In addition, the third reservoir chamber 3103 may be hydraulically connected to the second hydraulic pressure circuit 1600.

The fourth reservoir chamber 3104 may communicate with the third reservoir flow path 1730 and be connected to the auxiliary brake module 200. For example, the fourth reservoir chamber 3104 may be connected to upstream sides of the auxiliary supply valves 2641a and 2642a of the auxiliary brake module 200 through the third reservoir flow path 1730.

The bulkheads 3105 may each be provided between adjacent reservoir chambers. At least a part of an upper end of each bulkhead 3105 may be open, thereby allowing adjacent reservoir chambers 1101, 1102, 1103, and 1104 to communicate with each other to allow the pressing medium to move. For example, when a large amount of pressing medium flows into the first reservoir chamber 3101, the pressing medium may pass through the upper end of the bulkhead 3105 be and may be transmitted to the second reservoir chamber 3102, the third reservoir chamber 3103, and/or the fourth reservoir chamber 3104.

In this way, since the reservoir 300 is provided by being partitioned into the first to fourth reservoir chambers 1101, 1102, 1103, and 1104, the stable operation of the electric brake system 1000 can be implemented. For example, when the reservoir 300 is formed as one chamber and the capacity of the pressing medium is insufficient, the pressing medium cannot be stably supplied not only to the hydraulic pressure supply device 1300, but also to the integrated master cylinder 1200 and the dump control unit 1800. Accordingly, by separately providing the reservoir 300, even when the pressing medium may not be supplied to one component, the braking of the vehicle can be implemented by supplying the pressing medium to another component.

The main brake module 100 may be electrically connected to the first control circuit 4100 and controlled by the first control circuit 4100.

The auxiliary brake module 200 may be electrically connected to the second control circuit 4500 and controlled by the second control circuit 4500.

FIG. 2 is a block diagram illustrating a configuration of a control circuit of the electric brake system according to one embodiment.

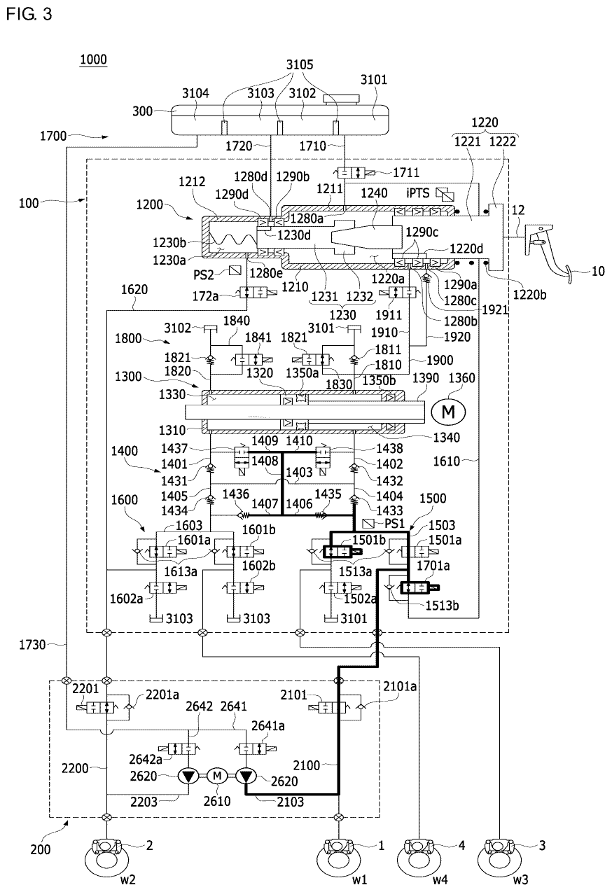

FIG. 3 is a view for describing failure diagnosis of the auxiliary brake module 200 according to one embodiment.

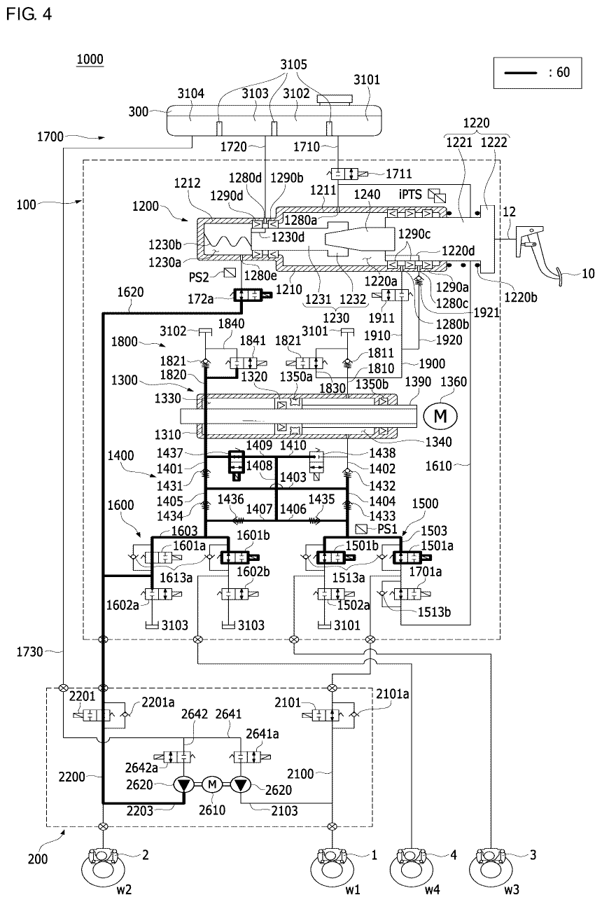

FIG. 4 is a view for describing the failure diagnosis of the auxiliary brake module 200 according to one embodiment.

Referring to FIG. 2, the electric brake system 1000 may include a main brake module 100, the auxiliary brake module 200, and/or a control circuit 400.

The main brake module 100 may be the main brake module 100 of FIG. 1 and may include a motor 1360 for generating a rotational force by a control signal of a first control circuit 4100 that receives an electrical signal of a first pedal displacement sensor 11 for a brake pedal 10, and a main valve block V1 including valves included in the main brake module 100 of FIG. 1.

The main valve block V1 may include a simulator valve 1711, a cut valve 172a, a test valve 1911, a test check valve 1921, a first inlet valve 1501a, a first outlet valve 1701a, a second inlet valve 1601a, a second outlet valve 1602a, a third inlet valve 1501b, a third outlet valve 1502a, a fourth inlet valve 1601b, a fourth outlet valve 1602b, and/or check valves 1513a, 1513b, and 1613a.

The auxiliary brake module 200 may be the auxiliary brake module 200 of FIG. 1 and may include a motor 2610 for generating a rotational force by a control signal of a second control circuit 4500 that receives an electrical signal of a second pedal displacement sensor 11′, and an auxiliary valve block V2 including valves included in the auxiliary brake module 200 of FIG. 1.

The auxiliary valve block V2 may include a first pressure control valve 2101, a second pressure control valve 2201, a first auxiliary supply valve 2641a, a second auxiliary supply valve 2642a, a first check valve 2101a, and/or a second check valve 2201a.

The control circuit 400 may include a first control circuit 4100 and a second control circuit 4500 of FIG. 1.

The first control circuit 4100 may include a plurality of semiconductor devices and may be named in various ways, such as an electronic control unit (ECU). The first control circuit 4100 may include, for example, one or more processors 4110, one or more memories 4120, and/or a communication circuit 4130.

The first control circuit 4100 may be electrically connected or communicatively connected to the second control circuit 4500 through the communication circuit 4130.

The first control circuit 4100 may receive a signal corresponding to a user's braking intention from the first pedal displacement sensor 11 and in response thereto, may provide an electrical signal for supplying or releasing a hydraulic pressure to or from wheel cylinders 1, 2, 3, and 4 to each of a hydraulic pressure supply device 1300 and a hydraulic pressure control unit 1400.

The first control circuit 4100 may receive a signal corresponding to a rotation speed of each wheel from a first wheel speed sensor 221 provided on a first wheel w1, a second wheel speed sensor 222 provided on a second wheel w2, a third wheel speed sensor 223 provided on a third wheel w3, and a fourth wheel speed sensor 224 provided on a fourth wheel w4. In addition, the first control circuit 4100 may provide the hydraulic pressure supply device 1300 and the hydraulic pressure control unit 1400 with an electric signal for supplying or releasing a hydraulic pressure to or from each of the wheel cylinders 1, 2, 3, and 4 in response to receiving the signal corresponding to the rotation speed of each wheel from each of the wheel speed sensors 221, 222, 223, and 224 to implement an anti-lock braking system (ABS).

For example, the first control circuit 4100 may receive the signal corresponding to the user's braking intention from the first pedal displacement sensor 11, and in response thereto, may control at least one valve and/or the motor 1360 of the main valve block V1.

The second control circuit 4500 may include a plurality of semiconductor devices and may be named in various ways, such as an ECU. The second control circuit 4500 may include, for example, one or more processors 4510, one or more memories 4520, and/or a communication circuit 4530.

The second control circuit 4500 may be electrically connected or communicatively connected to the first control circuit 4100 through the communication circuit 4530.

The second control circuit 4500 may identify whether the first control circuit 4100 is in a normal state or an abnormal state, that is, in an inoperable state, based on, for example, the reception of the signal from the first control circuit 4100 through communication with the first control circuit 4100 through the communication circuit 4530. In addition, the second control circuit 4500 may identify whether one component of the main brake module 100 is in a normal state or an inoperable state based on, for example, reception of the signal from the first control circuit 4100 through communication with the first control circuit 4100.

The second control circuit 4500 may control at least one valve and/or the motor 2610 of the auxiliary valve block V2 of the auxiliary brake module 200 when the main brake module 100, for example, the hydraulic pressure supply device 1300, is inoperable.

For example, the second control circuit 4500 may drive the motor 2610 to close the first pressure control valve 2101 and the second pressure control valve 2201 and open the first auxiliary supply valve 2641a and the second auxiliary supply valve 2642a upon receiving a braking request (or a demand deceleration signal) from an external controller while the hydraulic pressure supply device 1300 is inoperable.

The first control circuit 4100 and the second control circuit 4500 may diagnose a failure of the auxiliary brake module 200 of the electric brake system 1000. Based on the control of at least one valve included in the main valve block V1 by the first control circuit 4100, the control of at least one valve included in the auxiliary valve block V2 by the second control circuit 4500, and the control of the motor 2610, the failure diagnosis of the auxiliary brake module 200 may be performed.

The first control circuit 4100 and the second control circuit 4500 may perform first operation control in Table 1 below to diagnose the first auxiliary supply valve 2641a, for example, to identify whether a leak occurs. In Table 1, NO refers to a normal open type solenoid valve, and NC refers to a normal closed type solenoid valve.

TABLE 1

| | | Type | First | Second | Third | Fourth |
|---|---|---|---|---|---|---|
| | | of | operation | operation | operation | operation |
| | | valve | control | control | control | control |
| Main brake | Cut valve (172a) | NO | OFF | OFF | OFF | OFF |
| module (100) | First outlet | NO | ON | ON | ON | ON |
| | valve (1701a) | | | | | |
| | First inlet | NO | OFF | OFF | OFF | OFF |
| | valve (1501a) | | | | | |
| | Third inlet | NO | ON | ON | ON | ON |
| | valve (1501b) | | | | | |
| | Fourth inlet | NO | OFF | OFF | OFF | OFF |
| | valve (1601b) | | | | | |
| | Seventh valve | NC | OFF | OFF | ON | OFF |
| | (1437) | | | | | |
| | Second dump | NC | OFF | OFF | ON | OFF |
| | valve (1841) | | | | | |
| Auxiliary | First pressure | NO | OFF | OFF | OFF | ON |
| brake module | control valve | | | | | |
| (200) | (2101) | | | | | |
| | Second pressure | NO | OFF | OFF | OFF | OFF |
| | control valve | | | | | |
| | (2201) | | | | | |
| | First auxiliary | NC | OFF | ON | ON | ON |
| | supply valve | | | | | |
| | (2641a) | | | | | |
| | Second auxiliary | NC | OFF | OFF | OFF | OFF |
| | supply valve | | | | | |
| | (2642a) | | | | | |
| | Motor (2610) | — | ON | ON | OFF | ON |

Referring to the first operation control in Table 1, the first control circuit 4100 may turn on (or activate) the first outlet valve 1701a and the third inlet valve 1501b of the main brake module 100, and the second control circuit 4500 may drive (or turn on) the motor 2610. For example, the second control circuit 4500 may drive the motor 2610 after the first outlet valve 1701a and the third inlet valve 1501b are turned on.

As states of the first outlet valve 1701a and the third inlet valve 1501b are turned on, the first outlet valve 1701a and the third inlet valve 1501b that are the normal open type may be changed from an open state to a closed state.

In such a situation, when the motor 2610 is driven under the control of the second control circuit 4500, the first control circuit 4100 may identify whether the normal closed type first auxiliary supply valve 2641a is in a normal state or an abnormal state through an output signal of a circuit pressure sensor PS1. For example, the normal state of the first auxiliary supply valve 2641a may include a state in which no leak occurs, and the abnormal state of the first auxiliary supply valve 2641a may include a state in which a leak occurs.

When the first auxiliary supply valve 2641a is in a normal state, according to the above first operation control, the first auxiliary supply valve 2641a may maintain the closed state, the first inlet valve 1501a is in an open state, the seventh valve 1437 is in a closed state, and the eighth valve 1438 is also in a closed state. Therefore, as illustrated in FIG. 3, a pump 2620, the first auxiliary flow path 2103, the first auxiliary connection flow path 2100, a portion of the first hydraulic pressure circuit flow path 1503, which connects the first outlet valve 1701a to the third inlet valve 1501b, a fourth hydraulic pressure flow path 1404, a sixth hydraulic pressure flow path 1406, an eighth hydraulic pressure flow path 1408, a ninth hydraulic pressure flow path 1409, and a tenth hydraulic pressure flow path 1410 only communicate with each other from an outlet of the first auxiliary supply valve 2641a.

In such a state, when the motor 2610 is driven, the pump 2620 at the first auxiliary supply valve 2641a may not receive a pressing medium, thereby not causing an increase in a pressure of the first auxiliary flow path 2103, the first auxiliary connection flow path 2100, the portion of the first hydraulic pressure circuit flow path 1503, which connects the first outlet valve 1701a to the third inlet valve 1501b, the fourth hydraulic pressure flow path 1404, the sixth hydraulic pressure flow path 1406, the eighth hydraulic pressure flow path 1408, the ninth hydraulic pressure flow path 1409, and the tenth hydraulic pressure flow path 1410 that communicate with each other from the pump 2620 at the first auxiliary supply valve 2641a.

When the first auxiliary supply valve 2641a is in an abnormal state, the first auxiliary supply valve 2641a may not be completely closed. In such a state, when the motor 2610 is driven, the pressing medium may be transferred to the pump 2620 at the first auxiliary supply valve 2641a, thereby causing an increase in the pressure of the first auxiliary flow path 2103, the first auxiliary connection flow path 2100, the portion of the first hydraulic pressure circuit flow path 1503, which connects the first outlet valve 1701a to the third inlet valve 1501b, the fourth hydraulic pressure flow path 1404, the sixth hydraulic pressure flow path 1406, the eighth hydraulic pressure flow path 1408, the ninth hydraulic pressure flow path 1409, and the tenth hydraulic pressure flow path 1410 that communicate with each other from the pump 2620 at the first auxiliary supply valve 2641a.

Accordingly, the first control circuit 4100 may identify whether a leak occurs in the first auxiliary supply valve 2641a based on a pressure value acquired through the output signal of the circuit pressure sensor PS1 during the above first operation control.

The first control circuit 4100 may identify that a leak occurs in the first auxiliary supply valve 2641a when the pressure value acquired through the output signal of the circuit pressure sensor PS1 during the above first operation control increases. In addition, the first control circuit 4100 may identify that a leak does not occur in the first auxiliary supply valve 2641a when the pressure value acquired through the output signal of the circuit pressure sensor PS1 during the above first operation control is not increased.

For example, the first control circuit 4100 may identify whether a leak occurs in the first auxiliary supply valve 2641a when the pressure value acquired through the output signal of the circuit pressure sensor PS1 during the above first operation control increases to a predetermined reference pressure value or more. In addition, the first control circuit 4100 may identify that a leak does not occur in the first auxiliary supply valve 2641a when the pressure value acquired through the output signal of the circuit pressure sensor PS1 during the above first operation control increases to a value smaller than the predetermined reference pressure value.

The first control circuit 4100 and the second control circuit 4500 may perform the second operation control in Table 1 above to diagnose the motor 2610 and the pump 2620.

Referring to the second operation control in Table 1, the first control circuit 4100 may turn on (or activate) the first outlet valve 1701a and the third inlet valve 1501b of the main brake module 100, and the second control circuit 4500 may turn on the first auxiliary supply valve 2641a and drive (or turn on) the motor 2610.

For example, when the second operation control is performed after the above first operation control, the first control circuit 4100 may maintain the ON states of the first outlet valve 1701a and the third inlet valve 1501b. Alternatively, when the second operation control is performed before the above first operation control, the first control circuit 4100 may turn the first outlet valve 1701a and the third inlet valve 1501b on.

For example, the second control circuit 4500 may drive the motor 2610 after the first outlet valve 1701a, the third inlet valve 1501b, and the first auxiliary supply valve 2641a are turned on.

When the first outlet valve 1701a and the third inlet valve 1501b maintain the ON state by performing the second operation control after the above first operation control, the first outlet valve 1701a and the third inlet valve 1501b may maintain the closed state. Alternatively, as the first outlet valve 1701a and the third inlet valve 1501b are turned on by performing the second operation control before the above first operation control, the states of the first outlet valve 1701a and the third inlet valve 1501b that are the normal open type may be changed from an open state to a closed state.

In this case, since the first inlet valve 1501a is in an open state, the seventh valve 1437 is in a closed state, and the eighth valve 1438 is also in a closed state, as illustrated in FIG. 3, the first auxiliary flow path 2103, the first auxiliary connection flow path 2100, the portion of the first hydraulic pressure circuit flow path 1503, which connects the first outlet valve 1701a to the third inlet valve 1501b, the fourth hydraulic pressure flow path 1404, the sixth hydraulic pressure flow path 1406, the eighth hydraulic pressure flow path 1408, the ninth hydraulic pressure flow path 1409, and the tenth hydraulic pressure flow path 1410 may communicate with each other from the pump 2620 at the first auxiliary supply valve 2641a.

In addition, as the first auxiliary supply valve 2641a is turned on, the first auxiliary supply valve 2641a is changed from a closed state to an open state, and although not illustrated in FIG. 3, the pump 2620 at the first auxiliary supply valve 2641a may communicate with the reservoir 300 through the third reservoir flow path 1730 and the first auxiliary supply flow path 2641 so that the pressing medium may be transferred to the pump 2620 at the first auxiliary supply valve 2641a from the reservoir 300.

In such a situation, when the motor 2610 is driven under the control of the second control circuit 4500, the first control circuit 4100 may identify whether the motor 2610 and the pump 2620 at the first auxiliary supply valve 2641a are in a normal state or an abnormal state through the output signal of the circuit pressure sensor PS1.

In the case in which the motor 2610 and the pump 2620 at the first auxiliary supply valve 2641a are in a normal state, when the motor 2610 is driven, the pump 2620 at the first auxiliary supply valve 2641a may press the pressing medium, thereby causing an increase in the pressure of the first auxiliary flow path 2103, the first auxiliary connection flow path 2100, the portion of the first hydraulic pressure circuit flow path 1503, which connects the first outlet valve 1701a to the third inlet valve 1501b, the fourth hydraulic pressure flow path 1404, the sixth hydraulic pressure flow path 1406, the eighth hydraulic pressure flow path 1408, the ninth hydraulic pressure flow path 1409, and the tenth hydraulic pressure flow path 1410 that communicate with each other from the pump 2620 at the first auxiliary supply valve 2641a.

In the case in which at least one of the motor 2610 or the pump 2620 at the first auxiliary supply valve 2641a is in an abnormal state, when the second control circuit 4500 controls the driving of the motor 2610, this may not cause an increase in a pressure of the first auxiliary flow path 2103, the first auxiliary connection flow path 2100, the portion of the first hydraulic pressure circuit flow path 1503, which connects the first outlet valve 1701a to the third inlet valve 1501b, the fourth hydraulic pressure flow path 1404, the sixth hydraulic pressure flow path 1406, the eighth hydraulic pressure flow path 1408, the ninth hydraulic pressure flow path 1409, and the tenth hydraulic pressure flow path 1410 that communicate with each other from the pump 2620 at the first auxiliary supply valve 2641a.

Accordingly, the first control circuit 4100 may identify that the motor 2610 and the pump 2620 at the first auxiliary supply valve 2641a are in a normal state based on the pressure value acquired through the output signal of the circuit pressure sensor PS1 during the above second operation control or identify that at least one of the motor 2610 or the pump 2620 at the first auxiliary supply valve 2641a is in an abnormal state.

The first control circuit 4100 may identify that the motor 2610 and the pump 2620 at the first auxiliary supply valve 2641a are in a normal state when the pressure value acquired through the output signal of the circuit pressure sensor PS1 during the above second operation control increases. In addition, the first control circuit 4100 may identify that the motor 2610 and the pump 2620 at the first auxiliary supply valve 2641a are in an abnormal state when the pressure value acquired through the output signal of the circuit pressure sensor PS1 during the above second operation control is not increased.

For example, the first control circuit 4100 may identify that the motor 2610 and the pump 2620 at the first auxiliary supply valve 2641a are in a normal state when the pressure value acquired through the output signal of the circuit pressure sensor PS1 during the above second operation control increases to the predetermined reference pressure value or more. In addition, the first control circuit 4100 may identify that the motor 2610 and the pump 2620 at the first auxiliary supply valve 2641a are in an abnormal state when the pressure value acquired through the output signal of the circuit pressure sensor PS1 during the above second operation control increases to a value smaller than the predetermined reference pressure value.

The first control circuit 4100 and the second control circuit 4500 may perform the third operation control in Table 1 above to release the pressure generated in the hydraulic pressure circuit of the electric brake system 1000.

For example, the first control circuit 4100 and the second control circuit 4500 may perform the third operation control in Table 1 above to release the pressure generated in the hydraulic pressure circuit of the electric brake system 1000 by the first operation control and/or the second operation control for diagnosing the first auxiliary supply valve 2641a and/or diagnosing the motor 2610 and the pump 2620.

Referring to the third operation control in Table 1, the first control circuit 4100 may turn on (or activate) the first outlet valve 1701a, the third inlet valve 1501b, the seventh valve 1437, and the second dump valve 1841 of the main brake module 100, and the second control circuit 4500 may turn on the first auxiliary supply valve 2641a and drive (or turn on) the motor 2610.

For example, when performing the third operation control after the above first operation control or second operation control, the first control circuit 4100 may maintain the ON states of the first outlet valve 1701a and the third inlet valve 1501b and turn the seventh valve 1437 and the second dump valve 1841 on.

In addition, when performing the third operation control after the above first operation control, the second control circuit 4500 may turn on the first auxiliary supply valve 2641a and stop (or turn off) the driving of the motor 2610. Alternatively, when performing the third operation control after the above second operation control, the second control circuit 4500 may maintain the ON state of the first auxiliary supply valve 2641a and stop the driving of the motor 2610.

According to the performing of the above third operation control, the hydraulic pressure may be released (or the residual pressure may be removed) through the flow path communicating with the pump 2620 in the hydraulic pressure circuit of the electric brake system 1000.

After the first control circuit 4100 and the second control circuit 4500 release the pressure generated in the hydraulic pressure circuit of the electric brake system 1000 according to the third operation control, the fourth operation control in Table 1 above may be performed to diagnose the first pressure control valve 2101.

Referring to the fourth operation control in Table 1, the first control circuit 4100 may turn on (or activate) the first outlet valve 1701a and the third inlet valve 1501b of the main brake module 100 and turn off (or deactivate) the seventh valve 1437 and the second dump valve 1841 in the ON state, and the second control circuit 4500 may turn on the first pressure control valve 2101 and the first auxiliary supply valve 2641a of the auxiliary brake module 200 and drive the motor 2610.

For example, when performing the fourth operation control after the above third operation control, the first control circuit 4100 may maintain the ON states of the first outlet valve 1701a and the third inlet valve 1501b and change the ON states of the seventh valve 1437 and the second dump valve 1841 to OFF states. In addition, the second control circuit 4500 may turn on the first pressure control valve 2101 and maintain the ON state of the first auxiliary supply valve 2641a.

The second control circuit 4500 may drive the motor 2610 after the first outlet valve 1701a, the third inlet valve 1501b, the first pressure control valve 2101, and the first auxiliary supply valve 2641a are in an ON state and the seventh valve 1437 and the second dump valve 1841 are in an OFF state.

In such a situation, when the motor 2610 is driven under the control of the second control circuit 4500, the first control circuit 4100 may identify whether the first pressure control valve 2101 is in a normal state or an abnormal state through the output signal of the circuit pressure sensor PS1. For example, the normal state of the first pressure control valve 2101 may include a state in which no leak occurs, and the abnormal state of the first pressure control valve 2101 may include a state in which a leak occurs.

Although not illustrated in FIG. 3, when the first pressure control valve 2101 is in a normal state, the first pressure control valve 2101 is in a closed state, the first outlet valve 1701a and the third inlet valve 1501b are in a closed state, and the first auxiliary supply valve 2641a is in an open state so that the pump 2620 at the first auxiliary supply valve 2641a communicates with the reservoir 300 through the third reservoir flow path 1730 and the first auxiliary supply flow path 2641, and a downstream side of the first pressure control valve 2101 in the first auxiliary connection flow path 2100 may communicate with the pump 2620 through the first auxiliary flow path 2632. In such a state, when the motor 2610 is driven, a pressure of a portion provided with the circuit pressure sensor PS1 is not increased due to the closed state of the first pressure control valve 2101.

When the first pressure control valve 2101 is in an abnormal state, the first pressure control valve 2101 may not be completely closed. Accordingly, the first auxiliary connection flow path 2100, the portion of the first hydraulic pressure circuit flow path 1503, which connects the first outlet valve 1701a to the third inlet valve 1501b, and the fourth hydraulic pressure flow path 1404 may communicate with each other. In such a state, when the motor 2610 is driven, the pressure of the portion provided with the circuit pressure sensor PS1 increases due to pressing of the pressing medium of the pump 2620.

Accordingly, the first control circuit 4100 may identify whether a leak occurs in the first pressure control valve 2101 based on the pressure value acquired through the output signal of the circuit pressure sensor PS1 during the above fourth operation control.

The first control circuit 4100 may identify that a leak occurs in the first pressure control valve 2101 when the pressure value acquired through the output signal of the circuit pressure sensor PS1 during the above fourth operation control increases. In addition, the first control circuit 4100 may identify that a leak does not occur in the first pressure control valve 2101 when the pressure value acquired through the output signal of the circuit pressure sensor PS1 during the above fourth operation control is not increased.

For example, the first control circuit 4100 may identify whether a leak occurs in the first pressure control valve 2101 when the pressure value acquired through the output signal of the circuit pressure sensor PS1 during the above fourth operation control increases to the predetermined reference pressure value or more. In addition, the first control circuit 4100 may identify that a leak does not occur in the first pressure control valve 2101 when the pressure value acquired through the output signal of the circuit pressure sensor PS1 during the above second operation control increases to the value smaller than the predetermined reference pressure value.

The first control circuit 4100 and the second control circuit 4500 may sequentially perform control operations in the order of the above first operation control for diagnosing the first auxiliary supply valve 2641a, the above second operation control for diagnosing the motor 2610 and the pump 2620, the above third operation control for releasing the pressure, and the above fourth operation control for diagnosing the first pressure control valve 2101. Alternatively, the first control circuit 4100 and the second control circuit 4500 may sequentially perform control operations in the order of the above second operation control for diagnosing the motor 2610 and the pump 2620, the above first operation control for diagnosing the first auxiliary supply valve 2641a, the above third operation control for releasing the pressure, and the above fourth operation control for diagnosing the first pressure control valve 2101.

The first control circuit 4100 and the second control circuit 4500 may perform fifth operation control in Table 2 below to diagnose the second auxiliary supply valve 2642a, for example, to identify whether a leak occurs.

TABLE 2

| | | Type | Fifth | Sixth | Seventh | Eighth |
|---|---|---|---|---|---|---|
| | | of | operation | operation | operation | operation |
| | | valve | control | control | control | control |
| Main brake | Cut valve (172a) | NO | ON | ON | ON | ON |
| module (100) | First outlet | NO | OFF | OFF | OFF | OFF |
| | valve (1701a) | | | | | |
| | First inlet | NO | ON | ON | ON | ON |
| | valve (1501a) | | | | | |
| | Third inlet | NO | ON | ON | ON | ON |
| | valve (1501b) | | | | | |
| | Fourth inlet | NO | ON | ON | ON | ON |
| | valve (1601b) | | | | | |
| | Seventh valve | NC | OFF | OFF | ON | ON |
| | (1437) | | | | | |
| | Second dump | NC | OFF | OFF | ON | OFF |
| | valve (1841) | | | | | |
| Auxiliary | First pressure | NO | OFF | OFF | OFF | ON |
| brake module | control valve | | | | | |
| (200) | (2101) | | | | | |
| | Second pressure | NO | OFF | OFF | OFF | ON |
| | control valve | | | | | |
| | (2201) | | | | | |
| | First auxiliary | NC | OFF | OFF | OFF | OFF |
| | supply valve | | | | | |
| | (2641a) | | | | | |
| | Second auxiliary | NC | OFF | ON | ON | ON |
| | supply valve | | | | | |
| | (2642a) | | | | | |
| | Motor (2610) | | ON | ON | OFF | ON |

Referring to the fifth operation control in Table 2, the first control circuit 4100 may turn on (or activate) the cut valve 172a, the first inlet valve 1501a, the third inlet valve 1501b, and the fourth inlet valve 1601b of the main brake module 100, and the second control circuit 4500 may drive (or turn on) the motor 2610. For example, the second control circuit 4500 may drive the motor 2610 after the cut valve 172a, the first inlet valve 1501a, the third inlet valve 1501b, and the fourth inlet valve 1601b are turned on.

As states of the cut valve 172a, the first inlet valve 1501a, the third inlet valve 1501b, and the fourth inlet valve 1601b are turned on, the cut valve 172a, the first inlet valve 1501a, the third inlet valve 1501b, and the fourth inlet valve 1601b that are the normal open type may be changed from an open state to a closed state.

In such a situation, when the motor 2610 is driven under the control of the second control circuit 4500, the first control circuit 4100 may identify whether the normal closed type second auxiliary supply valve 2642a is in a normal state or an abnormal state through the output signal of the circuit pressure sensor PS1. For example, the normal state of the second auxiliary supply valve 2642a may include a state in which no leak occurs, and the abnormal state of the second auxiliary supply valve 2642a may include a state in which a leak occurs.

According to the above fifth operation control, when the second auxiliary supply valve 2642a is in a normal state, the second auxiliary supply valve 2642a may maintain the closed state. In addition, the second pressure control valve 2201 and the second inlet valve 1601a are in an open state. In addition, the first inlet valve 1501a, the third inlet valve 1501b, the fourth inlet valve 1601b, the seventh valve 1437, the eighth valve 1438, the cut valve 172a, and the second dump valve 1841 are in a closed state.

Accordingly, as illustrated in FIG. 4, one side of the cut valve 172a provided on the second connection flow path 1620 may communicate with the pump 2620 at the second auxiliary supply valve 2642a through the second auxiliary flow path 2203. In addition, as illustrated in FIG. 4, an outlet of the second valve 1432 provided on the second hydraulic pressure flow path 1402, one side of the eighth valve 1438 provided on the tenth hydraulic pressure flow path 1410, an inlet side of the first inlet valve 1501a of the first hydraulic pressure circuit flow path 1503, and an inlet side of the third inlet valve 1501b may communicate with the second connection flow path 1620. In addition, as illustrated in FIG. 4, an outlet of the second dump check valve 1821 provided on the second dump flow path 1820 and one side of the second dump valve 1841 may communicate with the second connection flow path 1620 through the pressure chamber 1330 via the fifth hydraulic pressure flow path 1405 and the first hydraulic pressure flow path 1401.

In such a state, when the motor 2610 is driven, the pump 2620 at the second auxiliary supply valve 2642a, the second auxiliary flow path 2203 communicating with the pump 2620 at the second auxiliary supply valve 2642a, the second auxiliary connection flow path 2200, the second connection flow path 1620, and the flow path 60 communicating with the second connection flow path 1620 may not receive the pressing medium, thereby not causing an increase in the pressure.

When the second auxiliary supply valve 2642a is in an abnormal state, the second auxiliary supply valve 2642a may not be completely closed. In such a state, when the motor 2610 is driven, the pressing medium may be transferred to the pump 2620 at the second auxiliary supply valve 2642a, thereby causing an increase in a pressure of the second auxiliary flow path 2203, the second auxiliary connection flow path 2200, the second connection flow path 1620, and the flow path 60 communicating with the second connection flow path 1620 that communicate with each other from the pump 2620 at the second auxiliary supply valve 2642a may not receive the pressing medium.

Accordingly, the first control circuit 4100 may identify whether a leak occurs in the second auxiliary supply valve 2642a based on the pressure value acquired through the output signal of the circuit pressure sensor PS1 during the above fifth operation control.

The first control circuit 4100 may identify that a leak occurs in the second auxiliary supply valve 2642a when the pressure value acquired through the output signal of the circuit pressure sensor PS1 during the above fifth operation control increases. In addition, the first control circuit 4100 may identify that a leak does not occur in the second auxiliary supply valve 2642a when the pressure value acquired through the output signal of the circuit pressure sensor PS1 during the above fifth operation control is not increased.

For example, the first control circuit 4100 may identify whether a leak occurs in the second auxiliary supply valve 2642a when the pressure value acquired through the output signal of the circuit pressure sensor PS1 during the above fifth operation control increases to a predetermined reference pressure value or more. In addition, the first control circuit 4100 may identify that a leak does not occur in the second auxiliary supply valve 2642a when the pressure value acquired through the output signal of the circuit pressure sensor PS1 during the above fifth operation control increases to a value smaller than the predetermined reference pressure value.

The first control circuit 4100 and the second control circuit 4500 may perform the sixth operation control in Table 2 above to diagnose the motor 2610 and the pump 2620.

Referring to the sixth operation control in Table 2, the first control circuit 4100 may turn on (or activate) the cut valve 172a, the first inlet valve 1501a, the third inlet valve 1501b, and the fourth inlet valve 1601b of the main brake module 100, and the second control circuit 4500 may turn on the second auxiliary supply valve 2642a and drive (or turn on) the motor 2610.

For example, when the sixth operation control is performed after the above fifth operation control, the first control circuit 4100 may maintain the ON states of the first inlet valve 1501a, the third inlet valve 1501b, and the fourth inlet valve 1601b. Alternatively, when the sixth operation control is performed before the above fifth operation control, the first control circuit 4100 may turn on the first inlet valve 1501a, the third inlet valve 1501b, and the fourth inlet valve 1601b.

For example, the second control circuit 4500 may drive the motor 2610 after the cut valve 172a, the first inlet valve 1501a, the third inlet valve 1501b, the fourth inlet valve 1601b, and the second auxiliary supply valve 2642a are turned on.

In this case, the second auxiliary supply valve 2642a is in an open state. In addition, the second pressure control valve 2201 and the second inlet valve 1601a are in an open state. In addition, the second outlet valve 1602a, the first inlet valve 1501a, the fourth inlet valve 1601b, the third inlet valve 1501b, the seventh valve 1437, the eighth valve 1438, the cut valve 172a, and the second dump valve 1841 are in a closed state.

Accordingly, as illustrated in FIG. 4, one side of the cut valve 172a provided on the second connection flow path 1620 may communicate with the pump 2620 at the second auxiliary supply valve 2642a through the second auxiliary flow path 2203. In addition, as illustrated in FIG. 4, an outlet of the second valve 1432 provided on the second hydraulic pressure flow path 1402, one side of the eighth valve 1438 provided on the tenth hydraulic pressure flow path 1410, an inlet side of the first inlet valve 1501a of the first hydraulic pressure circuit flow path 1503, and an inlet side of the third inlet valve 1501b may communicate with the second connection flow path 1620. In addition, as illustrated in FIG. 4, an outlet of the second dump check valve 1821 provided on the second dump flow path 1820 and one side of the second dump valve 1841 may communicate with the second connection flow path 1620 through the pressure chamber 1330 via the fifth hydraulic pressure flow path 1405 and the first hydraulic pressure flow path 1401.

Additionally, although not illustrated in FIG. 4, the pump at the second auxiliary supply valve 2642a may communicate with the reservoir 300 through the third reservoir flow path 1730 and the second auxiliary supply flow path 2642 so that the pressing medium may be transferred to the pump 2620 at the second auxiliary supply valve 2642a from the reservoir 300.

In such a situation, when the motor 2610 is driven under the control of the second control circuit 4500, the first control circuit 4100 may identify whether the motor 2610 and the pump 2620 at the second auxiliary supply valve 2642a are in a normal state or an abnormal state through the output signal of the circuit pressure sensor PS1.

In the case in which the motor 2610 and the pump 2620 at the second auxiliary supply valve 2642a are in a normal state, when the motor 2610 is driven, the pump 2620 at the second auxiliary supply valve 2642a may press the pressing medium, thereby causing an increase in a pressure of the second auxiliary flow path 2203, the second auxiliary connection flow path 2200, and the flow path 60 communicating with the second auxiliary connection flow path 2200 that communicate with each other from the pump 2620 at the second auxiliary supply valve 2642a.

In the case in which at least one of the motor 2610 or the pump 2620 at the second auxiliary supply valve 2642a is in an abnormal state, when the second control circuit 4500 controls the driving of the motor 2610, this may not cause an increase in the pressure of the second auxiliary flow path 2203 communicating with the pump 2620 at the second auxiliary supply valve 2642a, the second auxiliary connection flow path 2200, and the flow path 60 communicating with the second auxiliary connection flow path 2200.

Accordingly, the first control circuit 4100 may identify that the motor 2610 and the pump 2620 at the second auxiliary supply valve 2642a are in a normal state based on the pressure value acquired through the output signal of the circuit pressure sensor PS1 during the above sixth operation control or identify that at least one of the motor 2610 or the pump 2620 at the second auxiliary supply valve 2642a is in an abnormal state.

The first control circuit 4100 may identify that the motor 2610 and the pump 2620 at the second auxiliary supply valve 2642a are in a normal state when the pressure value acquired through the output signal of the circuit pressure sensor PS1 during the above sixth operation control increases. In addition, the first control circuit 4100 may identify that the motor 2610 and the pump 2620 at the second auxiliary supply valve 2642a are in an abnormal state when the pressure value acquired through the output signal of the circuit pressure sensor PS1 during the above sixth operation control is not increased.

For example, the first control circuit 4100 may identify that the motor 2610 and the pump 2620 at the second auxiliary supply valve 2642a are in a normal state when the pressure value acquired through the output signal of the circuit pressure sensor PS1 during the above sixth operation control increases to the predetermined reference pressure value or more. In addition, the first control circuit 4100 may identify that the motor 2610 and the pump 2620 at the second auxiliary supply valve 2642a are in an abnormal state when the pressure value acquired through the output signal of the circuit pressure sensor PS1 during the above sixth operation control increases to a value smaller than the predetermined reference pressure value.

The first control circuit 4100 and the second control circuit 4500 may perform the seventh operation control in Table 2 above to release the pressure generated in the hydraulic pressure circuit of the electric brake system 1000.

For example, the first control circuit 4100 and the second control circuit 4500 may perform the seventh operation control in Table 2 above to release the pressure generated in the hydraulic pressure circuit of the electric brake system 1000 by the fifth operation control and/or the sixth operation control for diagnosing the second auxiliary supply valve 2642a and/or diagnosing the motor 2610 and the pump 2620.

Referring to the seventh operation control in Table 2, the first control circuit 4100 may turn on (or activate) the cut valve 172a, the first inlet valve 1501a, the third inlet valve 1501b, the fourth inlet valve 1601b, the seventh valve 1437, and the second dump valve 1841 of the main brake module 100, and the second control circuit 4500 may turn on the second auxiliary supply valve 2642a and drive (or turn on) the motor 2610.

For example, when performing the seventh operation control after the above fifth operation control or sixth operation control, the first control circuit 4100 may maintain the ON states of the cut valve 172a, the first inlet valve 1501a, the third inlet valve 1501b, and the fourth inlet valve 1601b and turn on the seventh valve 1437 and the second dump valve 1841.

In addition, when performing the seventh operation control after the above fifth operation control, the second control circuit 4500 may turn on the second auxiliary supply valve 2642a and stop (or turn off) the driving of the motor 2610. Alternatively, when performing the seventh operation control after the above sixth operation control, the second control circuit 4500 may maintain the ON state of the second auxiliary supply valve 2642a and stop the driving of the motor 2610.

According to the performing of the above seventh operation control, the hydraulic pressure may be released (or the residual pressure may be removed) through the flow path communicating with the pump 2620 in the hydraulic pressure circuit of the electric brake system 1000.

After the first control circuit 4100 and the second control circuit 4500 release the pressure generated in the hydraulic pressure circuit of the electric brake system 1000 according to the seventh operation control, the eighth operation control in Table 2 above may be performed to diagnose the second pressure control valve 2201.

Referring to the eighth operation control in Table 2, the first control circuit 4100 may turn on (or activate) the cut valve 172a, the first inlet valve 1501a, the third inlet valve 1501b, the fourth inlet valve 1601b, and the seventh valve 1437 of the main brake module 100 and turn off (or deactivate) the second dump valve 1841 in the ON state, and the second control circuit 4500 may turn on the second pressure control valve 2201, the first pressure control valve 2101, and the second auxiliary supply valve 2642a of the auxiliary brake module 200 and drive the motor 2610.

For example, when performing the eighth operation control after the above seventh operation control, the first control circuit 4100 may maintain the ON states of the cut valve 172a, the first inlet valve 1501a, the third inlet valve 1501b, the fourth inlet valve 1601b, and the seventh valve 1437 and change the ON state of the second dump valve 1841 to an OFF state. In addition, the second control circuit 4500 may turn on the second pressure control valve 2201 and the first pressure control valve 2101 and maintain the ON state of the first auxiliary supply valve 2641a. Then, the second control circuit 4500 may drive the motor 2610.

In such a situation, when the motor 2610 is driven under the control of the second control circuit 4500, the first control circuit 4100 may identify whether the second pressure control valve 2201 is in a normal state or an abnormal state through the output signal of the circuit pressure sensor PS1. For example, the normal state of the second pressure control valve 2201 may include a state in which no leak occurs, and the abnormal state of the second pressure control valve 2201 may include a state in which a leak occurs.

Since the second pressure control valve 2201 is in a closed state when the second pressure control valve 2201 is in a normal state, when the motor 2610 is driven, the pressure of a portion provided with the circuit pressure sensor PS1 is not increased.

When the second pressure control valve 2201 is in an abnormal state, the second pressure control valve 2201 may not be completely closed. Accordingly, as illustrated in FIG. 4, one side of the cut valve 172a provided on the second connection flow path 1620 may communicate with the pump 2620 at the second auxiliary supply valve 2642a through the second auxiliary flow path 2203. In addition, as illustrated in FIG. 4, an outlet of the second valve 1432 provided on the second hydraulic pressure flow path 1402, one side of the eighth valve 1438 provided on the tenth hydraulic pressure flow path 1410, an inlet side of the first inlet valve 1501a of the first hydraulic pressure circuit flow path 1503, and an inlet side of the third inlet valve 1501b may communicate with the second connection flow path 1620. In addition, as illustrated in FIG. 4, an outlet of the second dump check valve 1821 provided on the second dump flow path 1820 and one side of the second dump valve 1841 may communicate with the second connection flow path 1620 through the pressure chamber 1330 via the fifth hydraulic pressure flow path 1405 and the first hydraulic pressure flow path 1401. In such a state, when the motor 2610 is driven, the pressure of the portion provided with the circuit pressure sensor PS1 increases due to pressing of the pressing medium of the pump 2620.

Accordingly, the first control circuit 4100 may identify whether a leak occurs in the second pressure control valve 2201 based on the pressure value acquired through the output signal of the circuit pressure sensor PS1 during the above eighth operation control.

The first control circuit 4100 may identify that a leak occurs in the second pressure control valve 2201 when the pressure value acquired through the output signal of the circuit pressure sensor PS1 during the above eighth operation control increases. In addition, the first control circuit 4100 may identify that a leak does not occur in the second pressure control valve 2201 when the pressure value acquired through the output signal of the circuit pressure sensor PS1 during the above eighth operation control is not increased.

For example, the first control circuit 4100 may identify whether a leak occurs in the second pressure control valve 2201 when the pressure value acquired through the output signal of the circuit pressure sensor PS1 during the above eighth operation control increases to the predetermined reference pressure value or more. In addition, the first control circuit 4100 may identify that a leak does not occur in the second pressure control valve 2201 when the pressure value acquired through the output signal of the circuit pressure sensor PS1 during the above eighth operation control increases to the value smaller than the predetermined reference pressure value.

The first control circuit 4100 and the second control circuit 4500 may sequentially perform control operations in the order of the above fifth operation control for diagnosing the second auxiliary supply valve 2642a, the above sixth operation control for diagnosing the motor 2610 and the pump 2620, the above seventh operation control for releasing the pressure, and the above eighth operation control for diagnosing the second pressure control valve 2201. Alternatively, the first control circuit 4100 and the second control circuit 4500 may sequentially perform control operations in the order of the above sixth operation control for diagnosing the motor 2610 and the pump 2620, the above fifth operation control for diagnosing the second auxiliary supply valve 2642a, the above seventh operation control for releasing the pressure, and the above eighth operation control for diagnosing the second pressure control valve 2201.

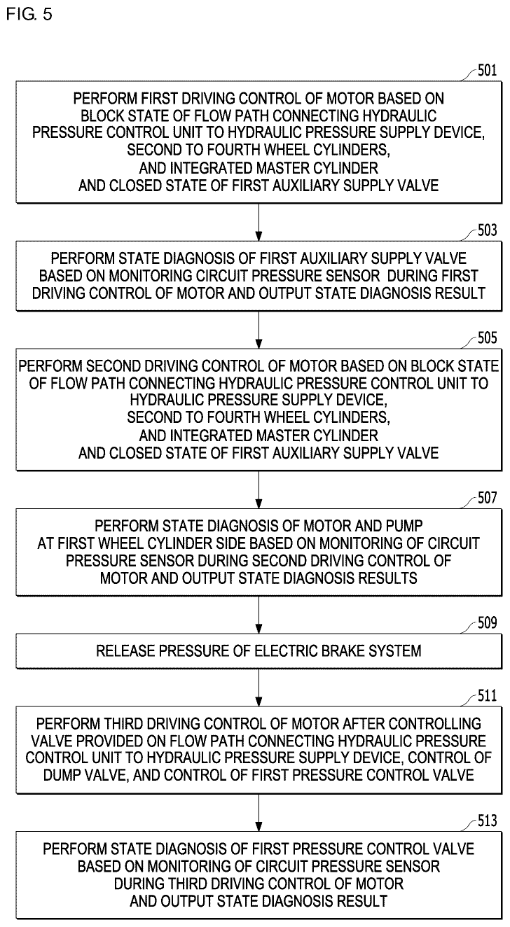

FIG. 5 is a flowchart of the control operation of the electric brake system 1000 (and/or the control circuit 400 (and/or the first control circuit 4100 and the second control circuit 4500)) according to one embodiment.

Referring to FIG. 5, the electric brake system 1000 may perform first driving control of the motor 2610 based on a blocking state of a flow path connecting the hydraulic pressure control unit 1400 to the hydraulic pressure supply device 1300, the second to fourth wheel cylinders 2, 3, and 4, and an integrated master cylinder 1200 and a closed state of the first auxiliary supply valve 2641a (501).

The electric brake system 1000 may turn on the corresponding valves so that the flow path connecting the hydraulic pressure control unit 1400 to the hydraulic pressure supply device 1300, the second to fourth wheel cylinders 2, 3, and 4, and the integrated master cylinder 1200 are blocked as in the operation control in Table 1 above and then drive the motor 2610, that is, perform the first driving control of the motor 2610.

The electric brake system 1000 may perform state diagnosis of the first auxiliary supply valve 2641a based on the monitoring of the circuit pressure sensor PS1 during the first driving control of the motor 2610 and output the state diagnosis result of the first auxiliary supply valve 2641a (503).

The electric brake system 1000 may determine that the first auxiliary supply valve 2641a is in an abnormal state when the pressure acquired through the output signal of the circuit pressure sensor PS1 is increased during the first driving control of the motor 2610.

The electric brake system 1000 may determine that the first auxiliary supply valve 2641a is in a normal state when the pressure acquired through the output signal of the circuit pressure sensor PS1 is not increased during the first driving control of the motor 2610.

The electric brake system 1000 may output the state diagnosis result of the first auxiliary supply valve 2641a to an output terminal electrically or communicatively connected to the electric brake system 1000.

The electric brake system 1000 may perform second driving control of the motor 2610 based on a blocking state of a flow path connecting the hydraulic pressure control unit 1400 to the hydraulic pressure supply device 1300, the second to fourth wheel cylinders 2, 3, and 4, and the integrated master cylinder 1200 and an open state of the first auxiliary supply valve 2641a (505).

As in the first operation control in Table 1 above, the electric brake system 1000 may maintain the turned-on states of the corresponding valves so that the flow path connecting the hydraulic pressure control unit 1400 to the hydraulic pressure supply device 1300, the second to fourth wheel cylinders 2, 3, and 4, and the integrated master cylinder 1200 is blocked and additionally, after controlling the first auxiliary supply valve 2641a to be in the open state, the electric brake system 1000 may drive the motor 2610, that is, perform the second driving control of the motor 2610.

The electric brake system 1000 may perform state diagnosis of the motor 2610 and the pump 2620 (referred to as a first pump) at the first wheel cylinder 1 side among the pair of pumps 2620 based on the monitoring of the circuit pressure sensor PS1 during the second driving control of the motor 2610 and output the results of the state diagnosis of the motor 2610 and the pump 2620 at the first wheel cylinder 1 side (507).

The electric brake system 1000 may determine that the motor 2610 and the pump 2620 at the first wheel cylinder 1 side are in a normal state when the pressure acquired through the output signal of the circuit pressure sensor PS1 is increased during the second driving control of the motor 2610.

The electric brake system 1000 may determine that the motor 2610 and the pump 2620 at the first wheel cylinder 1 side are in an abnormal state when the pressure acquired through the output signal of the circuit pressure sensor PS1 is not increased during the second driving control of the motor 2610.

The electric brake system 1000 may output the state diagnosis results of the motor 2610 and the pump 2620 at the first wheel cylinder 1 side to an output terminal electrically or communicatively connected to the electric brake system 1000.

The electric brake system 1000 may release the pressure of the electric brake system 1000 (509).

To release the pressure of the electric brake system 1000, the electric brake system 1000 may control the motor 2610 to be in an inactive state, control the first auxiliary supply valve 2641a to be in an open state, control the valve (the seventh valve 1437) provided on the flow path connecting the hydraulic pressure control unit 1400 to the hydraulic pressure supply device 1300 so that the flow path connecting the hydraulic pressure control unit 1400 to the hydraulic pressure supply device 1300 is connected, and control the dump valve (the second dump valve 1841) to be in an open state.

The control for releasing the pressure of the electric brake system 1000 may correspond to the third operation control in Table 1 above.

After the pressure of the electric brake system 1000 is released, the electric brake system 1000 may perform the third driving control of the motor 2610 after controlling the valve (the seventh valve 1437) provided on the flow path connecting the hydraulic pressure control unit 1400 to the hydraulic pressure supply device 1300 to block the flow path connecting the hydraulic pressure control unit 1400 to the hydraulic pressure supply device 1300, controlling the dump valve (the second dump valve 1841) to be in a closed state, and controlling the first pressure control valve 2101 to be in an open state (511).

The third driving control of the motor 2610 after the control of the valve (the seventh valve 1437), the control of the dump valve (the second dump valve 1841), and the control of the first pressure control valve 2101 may correspond to the fourth operation control in Table 1 above.

The electric brake system 1000 may perform state diagnosis of the first pressure control valve 2101 based on the monitoring of the pressure acquired through the output signal of the circuit pressure sensor PS1 during the third driving control of the motor 2610 and output the state diagnosis result of the first pressure control valve 2101 (513).

The electric brake system 1000 may determine that the first pressure control valve 2101 is in an abnormal state when the pressure acquired through the output signal of the circuit pressure sensor PS1 is increased during the third driving control of the motor 2610.

The electric brake system 1000 may determine that the first pressure control valve 2101 is in a normal state when the pressure acquired through the output signal of the circuit pressure sensor PS1 is not increased during the third driving control of the motor 2610.

The electric brake system 1000 may output the state diagnosis result of the first pressure control valve 2101 to an output terminal electrically or communicatively connected to the electric brake system 1000.

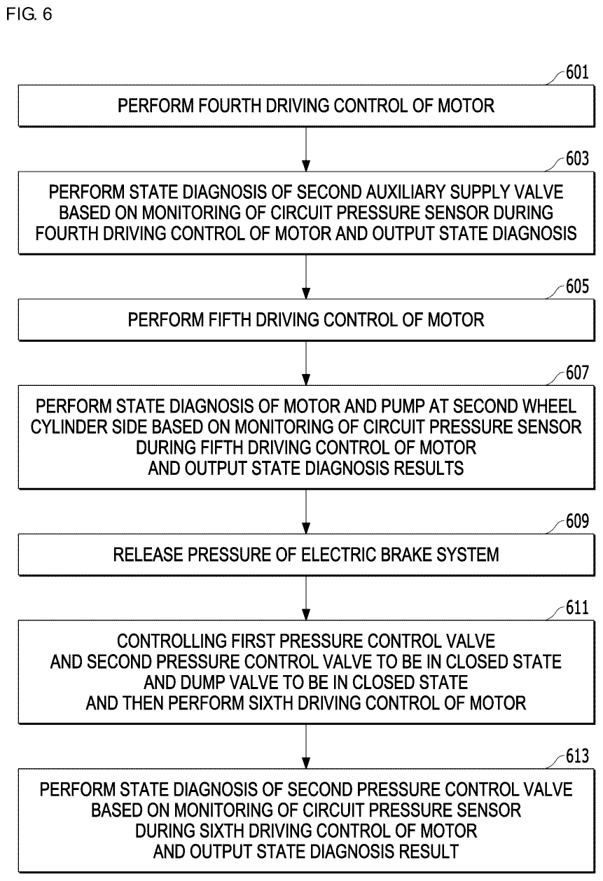

FIG. 6 is a flowchart of the control operation of the electric brake system 1000 (and/or the control circuit 400 (and/or the first control circuit 4100 and the second control circuit 4500)) according to one embodiment.

Referring to FIG. 6, the electric brake system 1000 may perform fourth driving control of the motor 2610 based on the state of connection of the connection flow path (the second connection flow path 1620), which connects the integrated master cylinder 1200, to the second wheel cylinder 2, to the hydraulic pressure control unit 1400 and blocking of flow paths connecting the first, third, and fourth wheel cylinders 1, 3, and 4 to the hydraulic pressure control unit 1400, a closed state of the cut valve 172a, and a closed state of the second auxiliary supply valve 2642a (601).

As in the above fifth operation control in Table 2, the electric brake system 1000 may connect the connection flow (the second connection flow path 1620) connecting the integrated master cylinder 1200 to the second wheel cylinder 2 to the hydraulic pressure control unit 1400, turn on valves so that the flow paths connecting the first, third, and fourth wheel cylinders 1, 3, and 4 to the hydraulic pressure control unit 1400 are blocked, turn on the cut valve 172a to be in a closed state, and then drive the motor 2610, that is, perform the fourth driving control.

The electric brake system 1000 may perform state diagnosis of the second auxiliary supply valve 2642a based on the monitoring of the circuit pressure sensor PS1 during the fifth driving control of the motor 2610 and output the state diagnosis result of second auxiliary supply valve 2642a (603).

The electric brake system 1000 may determine that the second auxiliary supply valve 2642a is in an abnormal state when the pressure acquired through the output signal of the circuit pressure sensor PS1 is increased during the fourth driving control of the motor 2610.

The electric brake system 1000 may determine that the second auxiliary supply valve 2642a is in a normal state when the pressure acquired through the output signal of the circuit pressure sensor PS1 is not increased during the fourth driving control of the motor 2610.

The electric brake system 1000 may output the state diagnosis result of the second auxiliary supply valve 2642a to an output terminal electrically or communicatively connected to the electric brake system 1000.

The electric brake system 1000 may perform fifth driving control of the motor 2610 based on the state of connection of the connection flow path (the second connection flow path 1620), which connects the integrated master cylinder 1200, to the second wheel cylinder 2, to the hydraulic pressure control unit 1400 and blocking of the flow paths connecting the first, third, and fourth wheel cylinders 1, 3, and 4 to the hydraulic pressure control unit 1400, a closed state of the cut valve 172a, and an open state of the second auxiliary supply valve 2642a (605).

As in the above sixth operation control in Table 2, the electric brake system 1000 may connect the connection flow (the second connection flow path 1620) connecting the integrated master cylinder 1200 to the second wheel cylinder 2 to the hydraulic pressure control unit 1400, maintain the blocking states of the flow paths connecting the first, third, and fourth wheel cylinders 1, 3, and 4 to the hydraulic pressure control unit 1400 and the closed state of the cut valve 172a, additionally, control the second auxiliary supply valve 2642a to be in an open state, and then drive the motor 2610, that is, performing the fifth driving control of the motor 2610.

The electric brake system 1000 may perform state diagnosis of the motor 2610 and the pump 2620 (referred to as a second pump) at the second wheel cylinder 2 side among the pair of pumps 2620 based on the monitoring of the circuit pressure sensor PS1 during the fifth driving control of the motor 2610 and output the result of the state diagnosis of the motor 2610 and the pump 2620 (607).

The electric brake system 1000 may determine that the motor 2610 and the pump 2620 at the second wheel cylinder 2 side are in a normal state when the pressure acquired through the output signal of the circuit pressure sensor PS1 is increased during the fifth driving control of the motor 2610.

The electric brake system 1000 may determine that the motor 2610 and the pump 2620 at the second wheel cylinder 2 side are in an abnormal state when the pressure acquired through the output signal of the circuit pressure sensor PS1 is not increased during the fifth driving control of the motor 2610.

The electric brake system 1000 may output the state diagnosis result of the motor 2610 and the pump 2620 at the second wheel cylinder 2 side to an output terminal electrically or communicatively connected to the electric brake system 1000.

The electric brake system 1000 may release the pressure of the electric brake system 1000 (609).

To release the pressure of the electric brake system 1000, the electric brake system 1000 may control the motor 2610 to be in an inactive state, control the second auxiliary supply valve 2642a to be in an open state, control the valve (the seventh valve 1437), control the dump valve (the second dump valve 1841) to be in an open state, and control the first pressure control valve 2101 and the second pressure control valve 2201 to be in an open state.

The control for releasing the pressure of the electric brake system 1000 may correspond to the above seventh operation control in Table 2.

The electric brake system 1000 may release the pressure of the electric brake system 1000, then control the first pressure control valve 2101 and the second pressure control valve 2201 to be in a closed state and control the dump valve (the second dump valve 1841) to be in a closed state, and then perform sixth driving control of the motor 2610 (611).

The sixth driving control of the motor 2610 after the control of the first pressure control valve 2101 and the second pressure control valve 2201 and the control of the dump valve (the second dump valve 1841) may correspond to the above eighth operation control in Table 2.

The electric brake system 1000 may perform state diagnosis of the second pressure control valve 2201 based on the monitoring of the pressure acquired through the output signal of the circuit pressure sensor PS1 during the sixth driving control of the motor 2610 and output the result of the state diagnosis of the second pressure control valve 2201 (613).

The electric brake system 1000 may determine that the second pressure control valve 2201 is in an abnormal state when the pressure acquired through the output signal of the circuit pressure sensor PS1 is increased during the sixth driving control of the motor 2610.

The electric brake system 1000 may determine that the second pressure control valve 2201 is in a normal state when the pressure acquired through the output signal of the circuit pressure sensor PS1 is not increased during the sixth driving control of the motor 2610.

The electric brake system 1000 may output the state diagnosis result of the second pressure control valve 2201 to an output terminal electrically or communicatively connected to the electric brake system 1000.

As is apparent from the above description, the electric brake system 1000 and the method of controlling the same according to the above-described embodiments can improve braking performance and operation reliability.

For example, the electric brake system and the method of controlling the same can provide a failure diagnosis technology of the electric brake system 1000.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. An electric brake system comprising:
a hydraulic pressure control unit provided between a hydraulic pressure supply device configured to generate a hydraulic pressure of a pressing medium and a plurality of wheel cylinders to transfer the hydraulic pressure generated from the hydraulic pressure supply device to the plurality of wheel cylinders;
a pressure sensor configured to detect a pressure of the hydraulic pressure control unit;
an auxiliary brake module including a first pump configured to press the pressing medium and discharge the pressing medium to a first wheel cylinder among the plurality of wheel cylinders, a motor configured to drive the first pump, and a first auxiliary supply valve configured to control the pressing medium to be supplied to the first pump; and
a control circuit electrically connected to the hydraulic pressure control unit, the pressure sensor, and the auxiliary brake module,
wherein the control circuit is configured to:
control the hydraulic pressure control unit to block flow paths connecting the hydraulic pressure control unit to the hydraulic pressure supply device, wheel cylinders excluding the first wheel cylinder among the plurality of wheel cylinders and an integrated master cylinder;
perform driving control of the motor in a blocked state of the flow path; and
diagnose a state of at least one of the first pump, the motor, or the first auxiliary supply valve based on monitoring of a pressure acquired during the driving control of the motor.

2. The electric brake system according to claim 1, wherein the control circuit is configured to:
perform first driving control of the motor based on the blocked flow path and a closed state of the first auxiliary supply valve;
diagnose a state of the first auxiliary supply valve based on monitoring of a pressure acquired through an output signal of the pressure sensor during the first driving control of the motor;
perform second driving control of the motor based on the blocked flow path and an open state of the first auxiliary supply valve; and
diagnose states of the first pump and the motor based on the monitoring of the pressure acquired through the output signal of the pressure sensor during the second driving control of the motor.

3. The electric brake system of claim 2, wherein the control circuit is configured to:
determine that the first auxiliary supply valve is in an abnormal state when the pressure acquired through the output signal of the pressure sensor is increased during the first driving control of the motor; and
determine that the first auxiliary supply valve is in a normal state when the pressure acquired through the output signal of the pressure sensor is not increased during the first driving control of the motor.

4. The electric brake system according to claim 2, wherein the control circuit is configured to:
determine that the first pump and the motor are in a normal state when the pressure acquired through the output signal of the pressure sensor is increased during the second driving control of the motor; and
determine that at least one of the first pump or the motor is in an abnormal state when the pressure acquired through the output signal of the pressure sensor is not increased during the second driving control of the motor.

5. The electric brake system of claim 1, wherein the auxiliary brake module further includes a first auxiliary flow path configured to transfer the pressing medium pressed by the first pump to the first wheel cylinder, and a first pressure control valve configured to control a pressure of the first auxiliary flow path, and
the control circuit controls the first pressure control valve to be in a closed state or an open state.

6. The electric brake system according to claim 5, further comprising a dump valve provided on a dump flow path connecting the hydraulic pressure supply device to a reservoir to control a flow of the pressing medium,
wherein the control circuit is configured to:
after releasing the pressure of the electric brake system, control a valve provided on a flow path connecting the hydraulic pressure control unit to the hydraulic pressure supply device to block the flow path connecting the hydraulic pressure control unit to the hydraulic pressure supply device, control the dump valve to be in a closed state, and control the first pressure control valve to be in an open state;
perform third driving control of the motor based on the blocked flow path connecting the hydraulic pressure control unit to the hydraulic pressure supply device, the closed state of the dump valve, and the open state of the first pressure control valve; and
diagnose a state of the first pressure control valve based on monitoring of a pressure acquired through an output signal of the pressure sensor during the third driving control of the motor.

7. The electric brake system according to claim 6, wherein the control circuit is configured to:
determine that the first pressure control valve is in an abnormal state when the pressure acquired through the output signal of the pressure sensor is increased during the third driving control of the motor; and
determine that the first pressure control valve is in a normal state when the pressure acquired through the output signal of the pressure sensor is not increased during the third driving control of the motor.

8. The electric brake system according to claim 6, wherein, to release the pressure of the electric brake system, the control circuit controls the motor to be in an inactive state, controls the first auxiliary supply unit to be in an open state, controls a valve provided on the flow path connecting the hydraulic pressure control unit to the hydraulic pressure supply device to open the flow path connecting the hydraulic pressure control unit to the hydraulic pressure supply device, and controls the dump valve to be in an open state.

9. The electric brake system according to claim 1, wherein the auxiliary brake module further includes a second pump configured to press the pressing medium based on driving of the motor and discharge the pressing medium to a second wheel cylinder among the plurality of wheel cylinders, and a second auxiliary supply valve configured to control the pressing medium to be supplied to the second pump, and
the control circuit is configured to:
control the hydraulic pressure control unit to connect a connection flow path, which connects an integrated master cylinder to the second wheel cylinder, to the hydraulic pressure control unit and block flow paths connecting wheel cylinders excluding the second wheel cylinder to the hydraulic pressure control unit;
control a cut valve so that the cut valve provided on the connection flow path is in a closed state;
control the driving of the motor based on a state of connection of the connection flow path, which connects the integrated master cylinder, to the second wheel cylinder, to the hydraulic pressure control unit and blocking of the flow paths connecting the wheel cylinders excluding the second wheel cylinder to the hydraulic pressure control unit and the closed state of the cut valve; and
diagnose a state of at least one of the second pump, the motor, or the second auxiliary supply valve based on monitoring of a pressure acquired through an output signal of the pressure sensor during the driving control of the motor based on the state of connection of the connection flow path, which connects the integrated master cylinder, to the second wheel cylinder, to the hydraulic pressure control unit and blocking of the flow paths connecting the wheel cylinders excluding the second wheel cylinder to the hydraulic pressure control unit and the closed state of the cut valve.

10. The electric brake system according to claim 9, wherein the control circuit is configured to:
perform fourth driving control of the motor based on the state of connection of the connection flow path, which connects the integrated master cylinder, to the second wheel cylinder, to the hydraulic pressure control unit and blocking of the flow paths connecting the wheel cylinders excluding the second wheel cylinder to the hydraulic pressure control unit, the closed state of the cut valve, and the closed state of the second auxiliary supply valve;
diagnose a state of the second auxiliary supply valve based on the monitoring of the pressure acquired through the output signal of the pressure sensor during the fourth driving control of the motor;
perform fifth driving control of the motor based on the state of connection of the connection flow path, which connects the integrated master cylinder, to the second wheel cylinder, to the hydraulic pressure control unit and blocking of the flow paths connecting the wheel cylinders excluding the second wheel cylinder to the hydraulic pressure control unit, the closed state of the cut valve, and the open state of the second auxiliary supply valve; and
diagnose states of the second pump and the motor based on the monitoring of the pressure acquired through the output signal of the pressure sensor during the fifth driving control of the motor.

11. The electric brake system according to claim 10, wherein the control circuit is configured to:
determine that the second auxiliary supply valve is in an abnormal state when the pressure acquired through the output signal of the pressure sensor is increased during the fourth driving control of the motor; and
determine that the second auxiliary supply valve is in a normal state when the pressure acquired through the output signal of the pressure sensor is not increased during the fourth driving control of the motor.

12. The electric brake system according to claim 10, wherein the control circuit is configured to:
determine that the second pump and the motor are in a normal state when the pressure acquired through the output signal of the pressure sensor is increased during the fifth driving control of the motor; and
determine that at least one of the second pump or the motor is in an abnormal state when the pressure acquired through the output signal of the pressure sensor is not increased during the fifth driving control of the motor.

13. The electric brake system according to claim 9, further comprising a dump valve provided on a dump flow path connecting the hydraulic pressure supply device to a reservoir to control a flow of the pressing medium,
wherein the auxiliary brake module further includes a second auxiliary flow path configured to transfer the pressing medium pressed by the second pump to the second wheel cylinder, and a second pressure control valve configured to control a pressure of the second auxiliary flow path, and
the control circuit controls the second pressure control valve and the dump valve to be in a closed state or an open state.

14. The electric brake system according to claim 12, wherein the control circuit is configured to:
after releasing the pressure of the electric brake system, control the first pressure control valve and the second pressure control valve to be in a closed state and control the dump valve to be in an open state;
perform sixth driving control of the motor based on the closed states of the first pressure control valve and the second pressure control valve and the open state of the dump valve; and
diagnose a state of the second pressure control valve based on the monitoring of the pressure acquired through the output signal of the pressure sensor during the sixth driving control of the motor.

15. The electric brake system according to claim 14, wherein the control circuit is configured to:
determine that the second pressure control valve is in an abnormal state when the pressure acquired through the output signal of the pressure sensor is increased during the sixth driving control of the motor; and
determine that the second pressure control valve is in a normal state when the pressure acquired through the output signal of the pressure sensor is not increased during the sixth driving control of the motor.

16. The electric brake system according to claim 14, wherein, to release the pressure of the electric brake system, the control circuit controls the motor to be in an inactive state, controls the second auxiliary supply unit to be in an open state, controls a valve provided on the flow path connecting the hydraulic pressure control unit to the hydraulic pressure supply device to open the flow path connecting the hydraulic pressure control unit to the hydraulic pressure supply device, controls the dump valve to be in an open state, and controls the first pressure control valve and the second pressure control valve to be in an open state.

17. A method of controlling an electric brake system including a hydraulic pressure control unit provided between a hydraulic pressure supply device configured to generate a hydraulic pressure of a pressing medium and a plurality of wheel cylinders to transfer the hydraulic pressure generated from the hydraulic pressure supply device to the plurality of wheel cylinders, a pressure sensor configured to detect a pressure of the hydraulic pressure control unit, and an auxiliary brake module including a first pump configured to press the pressing medium and discharge the pressing medium to a first wheel cylinder among the plurality of wheel cylinders, a motor configured to drive the first pump, and a first auxiliary supply valve configured to control the pressing medium to be supplied to the first pump, the method comprising:
controlling the hydraulic pressure control unit to block flow paths connecting the hydraulic pressure control unit to the hydraulic pressure supply device, wheel cylinders excluding the first wheel cylinder among the plurality of wheel cylinders, and an integrated master cylinder;
performing driving control of the motor in a blocked state of the flow path; and
diagnosing a state of at least one of the first pump, the motor, or the first auxiliary supply valve based on monitoring of a pressure acquired during the driving control of the motor.

18. The method according to claim 17, wherein the performing of the driving control of the motor includes:
performing first driving control of the motor further based on a closed state of the first auxiliary supply valve; and
performing second driving control of the motor further based on an open state of the first auxiliary supply valve, and
the diagnosing of the state of at least one of the first pump, the motor, or the first auxiliary supply valve includes:
diagnosing a state of the first auxiliary supply valve based on monitoring of a pressure acquired through an output signal of the pressure sensor during the first driving control of the motor; and
diagnosing states of the first pump and the motor based on the monitoring of the pressure acquired through the output signal of the pressure sensor during the second driving control of the motor.

19. The method according to claim 17, wherein the auxiliary brake module further includes a first auxiliary flow path configured to transfer the pressing medium pressed by the pump to the first wheel cylinder, and a first pressure control valve configured to control a pressure of the first auxiliary flow path, and
the electric brake system further includes a dump valve provided on a dump flow path connecting the hydraulic pressure supply device to a reservoir to control a flow of the pressing medium.

20. The method according to claim 19, further comprising:
after releasing the pressure of the electric brake system, controlling a valve provided on a flow path connecting the hydraulic pressure control unit to the hydraulic pressure supply device to block the flow path connecting the hydraulic pressure control unit to the hydraulic pressure supply device, controlling the dump valve to be in a closed state, and controlling the first pressure control valve to be in an open state;
performing third driving control of the motor based on the blocked flow path connecting the hydraulic pressure control unit to the hydraulic pressure supply device, the closed state of the dump valve, and the open state of the first pressure control valve; and
diagnosing a state of the first pressure control valve based on monitoring of a pressure acquired through an output signal of the pressure sensor during the third driving control of the motor.
